(19) United States
(12) Patent Application Publication
(10) Pub. No.: US 2007/0003184 A1
(43) Pub. Date: Jan. 4, 2007

(54) Delay time adjustment device and optical receiver using it

(75) Inventors: Tomoo Takahara, Kawasaki (JP); Takeshi Hoshida, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kanagawa (JP)

(21) Appl. No.: 11/356,235

(22) Filed: Feb. 17, 2006

(30) Foreign Application Priority Data
Jul. 1, 2005 (JP) 2005-193524

(51) Int. Cl. G02B 6/12

(52) U.S. Cl. 385/14

(57) ABSTRACT

A substrate 10 comprises a pair of photo detector modules and a pair of amplifiers. On the rear (facing a drawing) of the substrate 10, a coplanar waveguide 30 is formed. a cathode terminal 16 of a PIN photodiode 11 and the input terminal 21 of the amplifier 20 are connected by a wire 27. The output terminals of the two amplifiers and a pair of ground terminals 23g are connected to the signal line (S) and a pair of ground lines (G) of the coplanar waveguide 30 by flexible substrates 40a and 40b), respectively. Two branched optical signals which two photo detector modules receive from a delay interferometer is combined on the signal line (S) of the coplanar waveguide 30 on which the signal lines of the flexible substrates 40a and 40b are connected, after electrical signals.

### BACKGROUND OF THE INVENTION

1. Field of the Invention

The present invention relates to a technology for demodulating optical signals modulated by differential phase shift keying (DPSK), and more particularly, relates to a delay time adjustment device for adjusting in such a way that when two branched optical signals are combined in a balanced receiver after photoelectric conversion, the respective delay times of both signals can be matched, and a optical receiver using the device.

2. Description of the Related Art

A photonic network is a technology for realizing a super-high speed/large capacity network by directly applying routing and switching to optical signals. In a photonic network, on the transmitting side, optical signals (optical signal) are digitally modulated and transmitted to a communication network, and on the receiving side, the digitally modulated optical signals are digitally demodulated and restored.

As the digital modulation method in a photonic network corresponding to high bit rate transmission of 40 Gb/s or more per wavelength, differential binary phase shift keying (DBPSK), differential quadrature phase shift keying (DQPSK) and the like used.

In DBPSK and DQPSK, differential coding is used for transmission and delay detection is used for reception. DBPSK is superior in optical noise tolerance and non-linear tolerance. DQPSK is also superior in wavelength analysis capacity and the like, since its baud rate is low. DBPSK and DQPSK also have an advantage of being strong against errors since its phase change has regularity. DQPSK includes return-to-zero (RZ)-DQPSK in which DQPSK signals are converted into return-to-zero pulses, carrier-suppressed (CS)RZ-DQPSK and the like.

FIG. 1 shows the circuit configuration of a (CS)RZ-DQPSK optical receiver for demodulating 40 Gb/s (CS)RZ-DQPSK optical signal (hereinafter called “DQPSK optical signal).

In the (CS)RZ-DQPSK optical receiver 1000 shown in FIG. 1, inputted DQPSK optical signal is branched into two. The branched lights are inputted delay interferometers 1110 and 1120, respectively.

The delay interferometer 1110 comprises an upper arm 1111a and lower arm 1111b, which constitute a Mach-Zehnder interferometer. The respective optical path lengths of the two arms are different, and they are structured in such a way that the relative difference in propagation time between the branched light propagating through the upper arm 1111a and the branched light propagating through the lower arm 1111b may become almost equal to the symbol cycle of data modulation speed. Specifically, the optical path length of the upper arm 1111a is structured longer than that of the lower arm 111b so that the propagation time of the upper arm 1111a may become longer than that of the lower arm 1111b by almost one symbol cycle of the data modulation. A delay unit 1112 shifts the phase of propagating light by π/4 by applying a proper voltage to the electrode of the lower arm 1111b.

The delay interferometer 1120 is structured almost the same as the delay interferometer 1110. Namely, it is structured in such a way that the relative difference in the propagation time of the branched light between the upper arm 1121a and the lower arm 1121b may become almost equal to the symbol cycle of the data modulation speed. The delay interferometer 1120 differs from the delay interferometer 1110 in that a delay unit 1122 shifts the phase of branched light propagating through the lower arm 1121b.

In the delay interferometer 1110, the respective branched light propagating through the upper arm 1111a and lower arm 1111b interfere with each other at an interference point 1113, and an optical signal generated by the interference is inputted to a balanced receiver 1130 composed of a differential photo detector and an amplifier.

The balanced receiver 1130 comprises a differential light receiver composed of two serially connected PIN photodiodes and an amplifier, and demodulates an optical signal inputted from the delay interferometer 1110 to an electrical signal a corresponding to data modulated by a transmitter. Then, the electrical signal is outputted to a 20 Gb/s clock data recovery (CDR) circuit 1150.

Similarly, in the delay interferometer 1120 too, the respective branched light propagating through the upper arm 1111a and lower arm 1111b interfere with each other at an interference point 1123, and an optical signal generated by the interference is inputted to a balanced receiver 1140 composed of a differential light receiver and an amplifier. A balanced receiver 1140 comprises a differential light receiver composed of two serially connected PIN photodiodes and an amplifier The balanced receiver 1140 demodulates an optical signal inputted from the delay interferometer 1120 to an electrical signal b corresponding to data modulated by a transmitter and outputs the electrical signal b to a 20 Gb/s CDR circuit 1160.

The CDR circuits 1150 and 1160 extract a clock which becomes a regenerating timing signal from the inputted electrical signals a and b, respectively, convert the electrical signals a and b into more stable electrical signals, based on the clock and output them to a framer circuit 1170. The framer circuit 1170 performs frame synchronization, such as SDH/SONNET/OTN or the like, frame generation, error correction by forward error correction (FFC) and the like.

In the (CS)RZ-DQPSK receiver 1000 so configured, it is important to match the delay times caused when combined after photoelectric conversion by the PIN photodiodes in the balanced receivers (1130 and 1140) after input light is branched and two pieces of the branched light pass through the delay interferometers (1110 and 1130).

Specifically, it is important to match the respective delay times of both electrical signals when a first electrical signal generated by photoelectric conversion by one PIN photodiode and a second electrical signal generated by photoelectric conversion by the other photodiode. A 40 Gb/s optical transmission system requires matching in units of pico-seconds (ps) of delay difference caused when they are combined.

FIGS. 2 through 2 show various forms of the module configuration of a circuit constituting the (CS)RZ-DQPSK receiver 1000 shown in FIG. 1.

The circuit configuration of the (CS)RZ-DQPSK receiver 1000 shown in FIG. 1 excluding the framer circuit 1170 are vertically symmetrical. Specifically, each of the upper half and lower half comprises a delay interferometer, a balanced receiver and a CDR circuit.

In this description, a circuit composed of a delay interferometer, a balanced receiver and a CDR circuit is called “unit” for convenience' sake. The point where the first and second electrical signals are combined is also called “combination point” for convenience' sake.

FIG. 2 shows the first configuration of the unit. The unit 2000 shown in FIG. 2 comprises a delay interferometer module 2110, optical paths 2120a and 2120b and a photo receiver module 2130.

The delay interferometer module 2110 has the same circuit configuration as the delay interferometers (1110 and 1120) shown in FIG. 1. The photo receiver module 2130 comprises the balanced receivers (1130 and 1140) and CDR circuits (1150 and 1160). The delay interferometer module 2110 and the photo receiver module 2130 are connected by two optical paths 2120a and 2120b. The optical path 2120a connects the interference point 2113 of the delay interferometer module 2110 with the PIN photodiode 2131a of the photo receiver module 2130. The optical path 2120b connects the interference point 2113 of the delay interferometer module 2110 with the PIN photodiode 2131b of the photo receiver module 2130.

In the unit 2000, one point on an electrical signal path connecting the anode of the PIN photodiode 2131a with the cathode of the PIN photodiode 2131b becomes the combination point 2113.

FIG. 3 shows the second configuration of the unit.

In the unit 3000 shown in FIG. 3, the delay interferometer module 2110 and a photo receiver module 2130 are incorporated.

In the unit 3000, one point on an electrical signal path connecting the anode of the PIN photodiode 3131a with the cathode of the PIN photodiode 3131b becomes the combination point 3132.

FIG. 4 shows the third configuration of the unit.

The unit 4000 shown in FIG. 3 comprises a delay interferometer module 4110, optical paths 4120a and 4120b and a photo receiver module 4130.

The unit 4000 differs from the unit 2000 in the configuration of the photo reveiver module. In the photo receiver module 4130 of the unit 4000, the respective photoelectric conversion outputs of the PIN photodiode 4131a and PIN photodiode 4231b are combined at the combination point 4233b after amplified by the amplifiers 4133a and 4133b, respectively, provided respectively. In this configuration, the cathode electrode or anode electrode of the PIN photodiodes 4133a and 4133b is connected to the input terminal of the amplifiers 4133a and 4133b.

FIG. 5 shows one structure of the photo receiver module with the circuit configuration shown in FIG. 2 or 3.

In the photo receiver module shown in FIG. 5, the anode terminal 5006 of the upper PIN photodiodes (2131a and 3131a) and the cathode terminal 5005 of the lower PIN photodiodes (2131b and 3131b), in the balanced receiver are wire-bonded. More specifically, the anode terminal 5006 of the upper PIN photodiodes (2131a and 3131a) and the signal line (S) of a grounded coplanar waveguide 5100 are connected by a wire 5007a. The cathode terminal 5005 of the lower PIN photodiodes (2131b and 3131b) and the signal line (S) of a grounded coplanar waveguide 5100 are connected by a wire 5007b.

FIG. 6 shows one structure of the photo receiver module with the circuit configuration shown in FIG. 4.

In the photo receiver module shown in FIG. 6, the anode terminal 5006a of the upper PIN photodiode 4131a and the input terminal 4135a of the first electrical amplifier 4133a are connected by a wire 5009a. The anode terminal 5006b of the lower PIN photodiode 4131b of the first electrical amplifier 4133a and the input terminal 4135b of the second electrical amplifier 4133b are connected by a wire 5009b. The output terminal 4137s and a pair of ground terminals 4137g are connected to the signal line (S) of a grounded coplanar waveguide 5200 and a pair of ground lines (G) by a wire 5010a. Furthermore, the output terminal 4137s of the second electrical amplifier 4133b and a pair of ground terminal 4137g are connected to the signal line (S) of the grounded coplanar waveguide 5200 and a pair of ground lines (G) by a wire 5010b.

In the photo receiver module shown in FIG. 6, the delay times can be matched by adjusting the respective lengths of the wire 5010a connecting the output terminal 4133s of the first electrical amplifier 4133a with the signal line (S) of the grounded coplanar waveguide 5200 and the wire 5010b connecting the output terminal 4133s of the second electrical amplifier 4133b with the signal line (S) of the grounded coplanar waveguide 5200.

FIG. 7 shows one structure of the optical receiver module using a DQPSK space light delay interferometer.

The optical reveiver module shown in FIG. 7 comprises a delay interferometer 6000, an optical path adjustment unit 6030, four focusing lenses 6041 and a photoelectric conversion unit 6050.

The delay interferometer 6000 comprises a collimation lens 6001, a light branching unit 6002, half mirrors 6003 and 6021, a 180-degree folding reflector 6011, a phase difference plate 6012 and a mirror 6022.

A DQPSK received optical signal is converted into a parallel light beam by the collimation lens 6001 and inputted to the light branching unit 6002. The light branching unit 6002 branches the light beam into two parallel light beams UpBm and DwnBm and inputs them to the half mirror 6003. The half mirror 6003 branches the inputted light beam UpBm into a first light beam UpBm which is perpendicularly reflected and inputted to the 180-degree folding reflector 6011 and a second light beam UpBm which pass through the half mirror 6003 and is inputted to the phase difference plate 6012. Similarly the half mirror 6003 also branches the inputted light beam DwnBm into a first light beam DwnBm and a second light beam DwnBm. The 180-degree folding reflector 6011 reflects the inputted first light beams UpBm and DwnBm by 90 degrees twice and inputs them to the half mirror 6021. The phase difference plate 6012 provides a phase difference π/2 to the inputted two second light beams UpBm and DwnBm and inputs them to the half mirror 6021.

The half mirror 6021 branches the first light beams UpBm and DwnBm that are folded by the 180-degree folding reflector 6011 and are inputted into a light beam which passes through the half mirror 6021 and inputted to the mirror 6022 and a light beam which is reflected by the half mirror 6021 and inputted to the optical path length adjustment unit 6030. Similarly the half mirror 6021 also branches the second light beams UpBm and DwnBm that pass through the phase difference plate 6012 into a light beam which is inputted to the optical path adjustment unit 6030 and a light beam which is inputted to the mirror 6022. The mirror 6022 reflects in parallel the light beams inputted from the half mirror 6021.

An optical path length, until it is folded by the 180-degree folding reflector 6011 and inputted to the half mirror 6021 after it is reflected by the half mirror 6003, corresponds to one symbol cycle of DQPSK modulation. π/2 phase difference is provided to the second light beams UpBm and DwnBm that pass through the phase difference plate 6012.

Therefore, in the half mirror 6021, the first light beam UpBm and the second light beam UpBm can interfere with each other, and also the first light beam DwnBm and the second light beam DwnBm can interfere with each other. Thus the respective strength of light beams UpBm and DwnBm can be demodulated.

Thus, light signals A and B are outputted from the half mirror 6021, and complementary light signals A and B are outputted from the mirror 6022. Therefore, the light signals of the delay interferometer 6000 are outputted as shown in FIG. 8.

In the photoelectric conversion unit 6050, PIN photo diodes 6051 for the light signal A, complementary light signal A, light signal B and complementary light signal B are provided from top in that order so that the wiring distance of the balanced receiver balanced receiver can be reduced and also high-speed optical signals can be received with high quality.

The optical path length adjustment unit 6030 is provided to modify the output position of the optical signal A and complementary optical signal B which are adjacently outputted from an optical delay interferometer 7000 in order to correctly perform photoelectric conversion in the PIN photodiode 6051 of the photoelectric conversion unit 6050. The optical path length adjustment unit 6030 comprises three glass objects 6031, 6033 and 6034. The optical paths of the optical signal A and the complementary optical signal B are exchanged by the glass object 6033.

The respective lengths in the direction of an optical path of the glass objects 6031, 6033 and 6034 of the photoelectric conversion unit 6050 are made in such a way that the respective optical path lengths between the half mirror 6021 of the delay interferometer 6000 and each PIN photodiode 6051 of the photoelectric conversion unit 6050 and between the mirror 6022 of the delay interferometer 6000 and each PIN photodiode 6051 of the photoelectric conversion unit 6050 can become almost equal.

Since in an optical path, a line difference of 1 mm corresponds to a delay difference of five ps (pico-second), in the DQPSK receiver, the optical path lengths and transmission line lengths of two optical signals branched after being inputted to a delay interferometer must be matched in units of several hundred μm.

However, the delay interferometer has a long optical path, and especially in the case of the unit 2000 shown in FIG. 2, it has a fiber interface, it is difficult to manufacture an optical system with accuracy of several hundred μm or less, and a compensation unit is needed.

In the photo receiver module configured as shown in FIG. 5 or 6, the delay times at combination can also matched by changing the bonding length of wire bonding.

In the photo receiver module shown in FIG. 5, the delay times at combination can also matched by adjusting the respective lengths of the wires 5007a and 5007b.

In the photo receiver module shown in FIG. 6, the delay times at combination can be matched by adjusting the respective lengths of the wire 5010a for connecting the output terminal 4133s of the first electrical amplifier 4133a and the signal line (S) of the grounded coplanar waveguide 5200 and the wire 5010b for connecting the output terminal 4133s of the second electrical amplifier 4133b and the signal line (S) of the grounded coplanar waveguide 5200.

However, when in the photo detector module configured as shown in FIG. 5 or 6, the delay times at combination are matched by adjusting the bonding length of the wire bonding, its influences on characteristics, such as an HF (High frequency) characteristic, loss, reflection and the like are great. Therefore, it is not suitable for the (CS)RZ-DQPSK receiver used in a high bit rate photonic network. Although an adjustment substrate, such as a ceramic substrate or the like can also be used, the ceramic substrate is expensive and also there is a restraint in its substrate size. Therefore, if it must be mass-produced, a product becomes expensive.

In the photo receiver module shown in FIG. 7, since the optical path length adjustment unit 6030 composed of the glass objects exchanges the optical paths, the size of the optical path length adjustment unit 6030 increases and its production cost increases. Therefore, it is difficult to reduce the size of the photo receiver module, and its cost increases.

### SUMMARY OF THE INVENTION

It is an object of the present invention to match the respective delay times of the two branched signals with high accuracy at a low cost when converting the two branched optical signals of the received optical signal DBPSK-modulated or DQPSK-modulated into electrical signals after delay interference and combining them.

The delay time control device of the present invention adjusts the respective delay times of two optical signals obtained by branching a received optical signal in a delay interferometer when converting them into electrical signals by a photo acceptance device and are combined after they interfere with each other in the delay interferometer for demodulating optical signals modulated by differential phase shift keying.

The first delay time control device of the present invention comprises at least one balanced receiver. The balanced receiver comprises a pair of photo acceptance devices for photoelectrically converting the two branched optical signals separately, a pair of amplifiers provided in correspondence with the pair of photo acceptance devices, for receiving/amplifying photoelectrically converted signals outputted from a corresponding photo acceptance device, and a flexible substrate for connecting the output terminals of the pair of amplifiers and a signal line on which the photoelectrically converted signals of the two branched optical signals are combined and adjusting the delay times of the two branched optical signals when branched optical signals are combined.

According to the first delay time control device of the present invention, since the flexible substrate connects the output terminal of the amplifier and the signal line for combining the photoelectrically converted signals of the two branched optical signals, in the balanced receiver, their delay times can be matched when combining the two blanched optical signals of the optical signal modulated by differential phase shift keying at a low cost and with high accuracy.

The second delay time control device of the present invention is according to the first delay time control device. The balanced receiver comprises a first photo acceptance device for converting one branched optical signal which must be outputted from the interferometer and must be combined into a first electrical signal, a first electrical amplifier for amplifying and outputting the electrical signal outputted from the first photo acceptance device, a first flexible substrate for connecting the output terminal of the first electrical amplifier and a signal line on which the combination is performed, a second photo acceptance device for converting the other branched optical signal which must be outputted from the interferometer and must be combined into a second electrical signal, a second electrical amplifier for amplifying and outputting the electrical signal outputted from the second photo acceptance device, and a second flexible substrate for connecting the output terminal of the second electrical amplifier and a signal line on which the combination is performed.

According to the second delay time control device of the present invention, for example, in a balanced receiver with a trans-impedance amplifying balanced type detector, their delay times can be matched at a low cost and with high accuracy when combining the two branched optical signals of an optical signal modulated by differential phase shift keying.

The third delay time control device of the present invention is according to the first delay time control device. The third delay time control device comprises at least one balanced receiver. The balanced receiver comprises two photo acceptance devices constituting a balanced receiver for photoelectrically converting the two branched optical signals individually, an amplifier with an input terminal to which electrical signals outputted from the two photo acceptance devices are inputted, a first flexible substrate for connecting the terminal of one photo acceptance device and the input terminal of the amplifier, and a second flexible substrate for connecting the terminal of the other photo acceptance device and the input terminal of the amplifier.

According to the third delay time control device of the present invention, since the flexible substrate connects the two photo acceptance devices constituting the balanced receiver and the amplifier, in the balanced receiver with the balanced type detector, their delay times can be matched at a low cost and with high accuracy when combining the two branched optical signals of an optical signal modulated by differential phase shift keying. The transmission line length between the photo acceptance device and amplifier can also be easily adjusted and extended.

The fourth delay time control device of the present invention is according to the second or third delay time control device. In the fourth delay time control device, the differential phase shift keying modulation is DBPSK modulation, and one the balanced receiver is provided.

According to the fourth delay time control device of the present invention, their delay times can be matched at a low cost and with high accuracy when combining two the branched optical signals of a DBPSK-modulated optical signal.

The fifth delay time control device of the present invention is according to the second or third delay time control device. In the fifth delay time control device, the differential phase shift keying modulation is DQPSK modulation, and two the balanced receivers are provided.

According to the fifth delay time control device of the present invention, their delay times can be matched at a low cost and with high accuracy when combining two the branched optical signals of a DQPSK-modulated optical signal.

The sixth delay time control device of the present invention is according to the first delay time control device. The delay time control device in the sixth aspect comprises two the balanced receivers. The total four amplifiers of the two balanced receivers are disposed in such a way that electrical signals to be combined may not be adjacently outputted, and a first flexible substrate for connecting the output terminals of two amplifiers for outputting two of the first electrical signals to be combined and the signal line for the combination and a second flexible substrate for connecting the output terminals of two amplifiers for outputting two of the second electrical signal to be combined and the signal line for the combination.

In the sixth delay time control device, the first and second flexible substrates are, for example, shaped almost in a Y character. The respective lengths of the two branching units of the first and second flexible substrates can be equal or different.

According to the sixth delay time control device of the present invention, even when the delay interferometer does not adjacently output the two branched optical signals to be combined, their delay times can be matched at a low cost and with high accuracy when combining the two branched optical signals of a DQPSK-modulated optical signal.

The seventh delay time control device of the present invention is according to the first delay time control device. The seventh delay time control device comprises a first wire for connecting the terminal of the first photo acceptance device and the input terminal of the first amplifier and a second wire for connecting the terminal of the second photo acceptance device and the input terminal of the second amplifier.

The respective lengths of the first and second wires can be, for example, different. Conversely they can also be equal.

According to the seventh delay time control device of the present invention, for example, even if in the delay interferometer id tilted due to the unevenness in thickness of adhesive or the like and as a result, the respective position of the photo acceptance devices are needed, their delay times can be rapidly/easily matched and compensated for when they are combined, by adjusting the length between the wire and flexible substrate.

The eighth delay time control device of the present invention is according to the first, second or sixth delay time control device. The flexible substrates are connected in a loop.

According to the eighth delay time control device of the present invention, since the wiring width in the direction parallel to the substrate (for example, longitudinally) can be reduced, the entire device can be miniaturized.

In the first, second, third or sixth delay time control device, the flexible substrate can also, for example, comprise a grounded coplanar waveguide and connect the output terminals of the pair of the amplifiers and the signal line for combining the photoelectrically converted signals of the two branched optical signals via the signal line of the grounded coplanar waveguide. Alternatively, the flexible substrate can also, for example, comprise a coplanar waveguide and connect the output terminals of the pair of the amplifiers and the signal line for combining the photoelectrically converted signals of the two branched optical signals via the signal line of the coplanar waveguide.

The first optical receiver of the present invention comprises the first, second or third delay time control device and demodulates DBPSK-modulated optical signals.

According to the first optical receiver, optical signals which are DBPSK-modulated and transmitted at a high bit rate of 40 Gb/s or more can be accurately received.

The second optical receiver of the present invention comprises the first, second or third delay time control device and demodulates DQPSK-modulated optical signals.

According to the second optical receiver, optical signals which are DQPSK-modulated and transmitted at a high bit rate of 40 Gb/s or more can be accurately received.

In the first and second optical receivers, for example, the optical receiver and flexible substrate are hermetically sealed.

By hermetically sealing in this way, the disadvantage of the flexible substrate, moisture resitance can be improved.

According to the present invention, the respective delay times of two photoelectrically converted branched optical signals can be matched with high accuracy and at a low cost in a optical receiver for receiving optical signals DBPSK-modulated or DQPSK-modulated.

### BRIEF DESCRIPTION OF THE DRAWINGS

FIG. 1 shows the circuit configuration of the (CS)RZ-DQPSK optical receiver for demodulating a 40 Gb/s (CS)RZ-DQPSK optical signal.

FIG. 2 is the first form of the module configuration of a circuit constituting the (CS)RZ-DQPSK receiver.

FIG. 3 is the second form of the module configuration of a circuit constituting the (CS)RZ-DQPSK receiver.

FIG. 4 is the third form of the module configuration of a circuit constituting a (CS)RZ-DQPSK receiver.

FIG. 5 shows one structure of a photo detector module with the circuit configuration shown in FIG. 2 or 3.

FIG. 6 shows one structure of a photo detector module with the circuit configuration shown in FIG. 4.

FIG. 7 shows a structure of a photo detector module using a DQPSK space light delay interferometer.

FIG. 8 shows output disposition form of a light signal of the DQPSK space light delay interferometer of the photo detector module shown in FIG. 7.

FIG. 9 shows the structure of a preferred embodiment obtained by applying the present invention to optical receiver module shown in FIG. 4.

FIG. 10 shows the first structure of the first and second flexible substrates shown in FIG. 9.

FIG. 11 shows the second structure of the first and second flexible substrates shown in FIG. 9.

FIG. 12 shows the third structure of the first and second flexible substrates shown in FIG. 9.

FIG. 13 shows the structure of a preferred embodiment obtained by applying the present invention to optical receiver module shown in FIG. 2 or 3.

FIG. 14 shows the major structure of a photo detector module suited to be used in combination with a delay interferometer for outputting optical signals arranged as shown in FIG. 8.

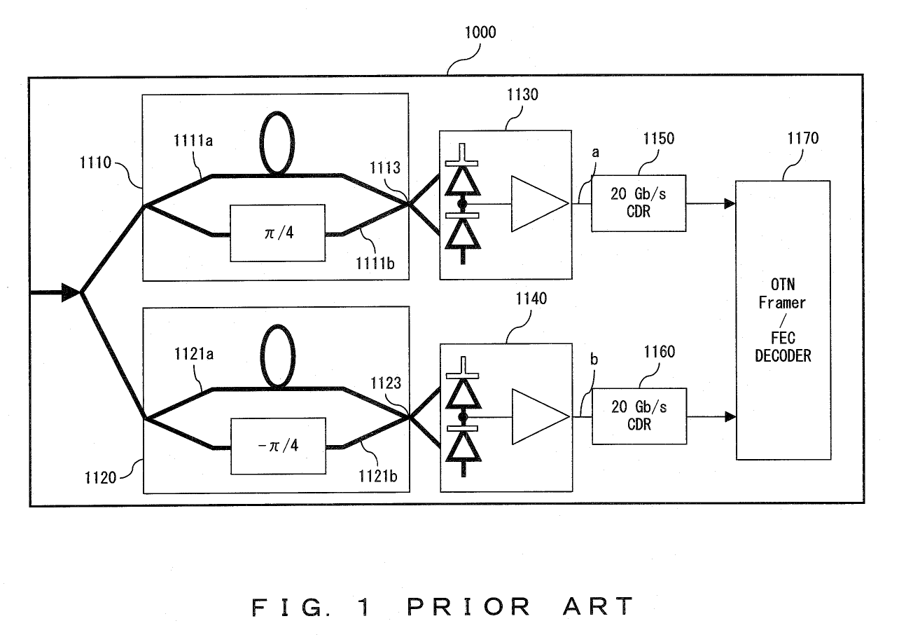

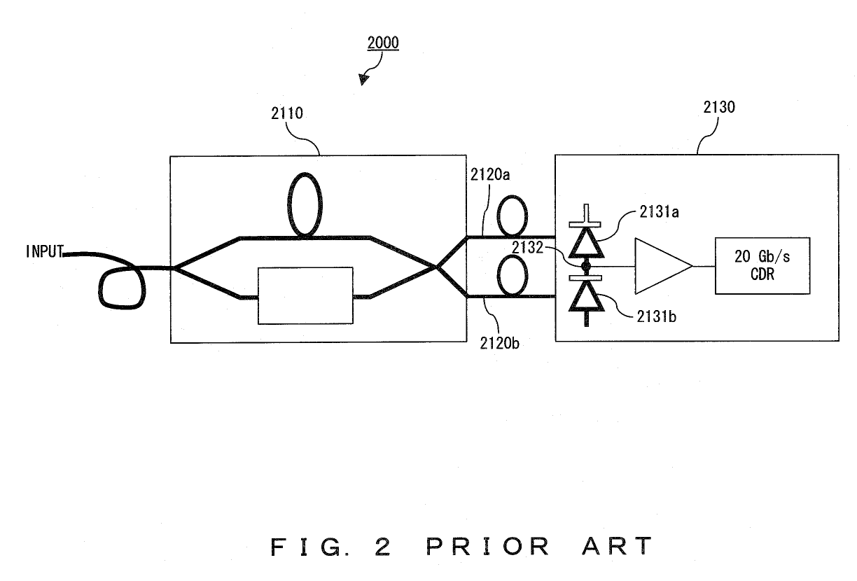

FIGS. 2. 15A through 15C show various shapes of flexible substrates used in the third preferred embodiment of the present invention.

FIG. 16 shows the detailed structure of the flexible substrate used in the third preferred embodiment of the present invention (No. 1).

FIG. 17 shows the detailed structure of the flexible substrate used in the third preferred embodiment of the present invention (No. 2).

FIG. 18 shows the structure of a photo detector module adopting a photoelectric conversion unit provided with an side illuminated Mirror type PIN photodiode.

FIG. 19 typically shows a first problem caused in the photo detector module structured as shown in FIG. 18.

FIG. 20 typically shows a new problem caused by solving the first problem by compensation.

FIG. 21 is the top views of the first structure of the flexible substrate in which the location of the photoelectric conversion unit is inclined to the left in order to compensate for influences due to the tilt of the delay interferometer.

FIG. 22 is the side view of the first structure of the flexible substrate.

FIG. 23 is the top views of the second structure of the flexible substrate in which the location of the photoelectric conversion unit is inclined to the left in order to compensate for influences due to the tilt of the delay interferometer.

FIG. 24 is the side view of the second structure of the flexible substrate.

FIG. 25 is the side view of the fifth preferred embodiment.

FIG. 26 shows the detailed structure of the photoelectric conversion unit used in the fifth preferred embodiment.

FIG. 27 shows the structure of the side illuminated Mirror type PIN photodiode.

FIG. 28 is the section view showing the package structure of the photo detector module in each preferred embodiment of the present invention.

### DESCRIPTION OF THE PREFERRED EMBODIMENTS

The preferred embodiments of the present invention are described below with reference to the drawings.

### The First Preferred Embodiment

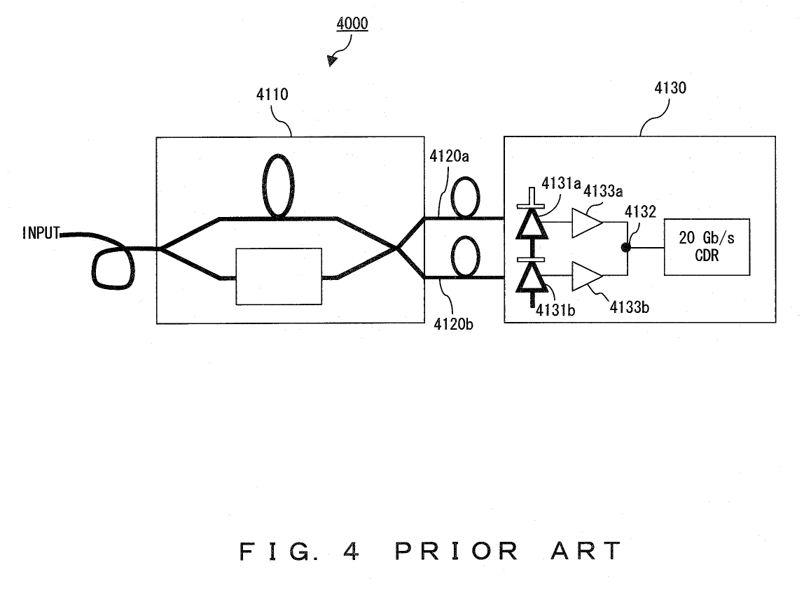

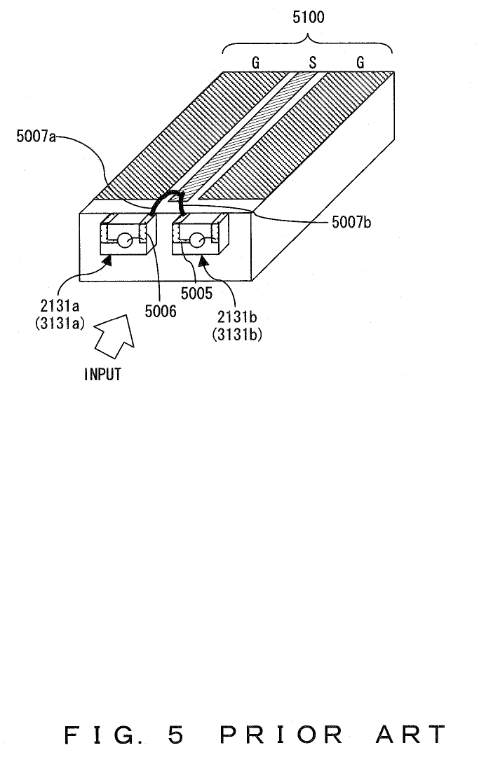

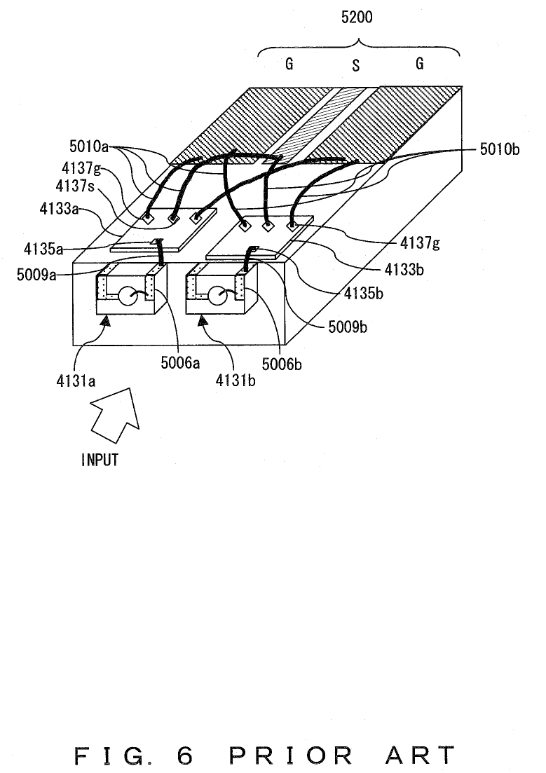

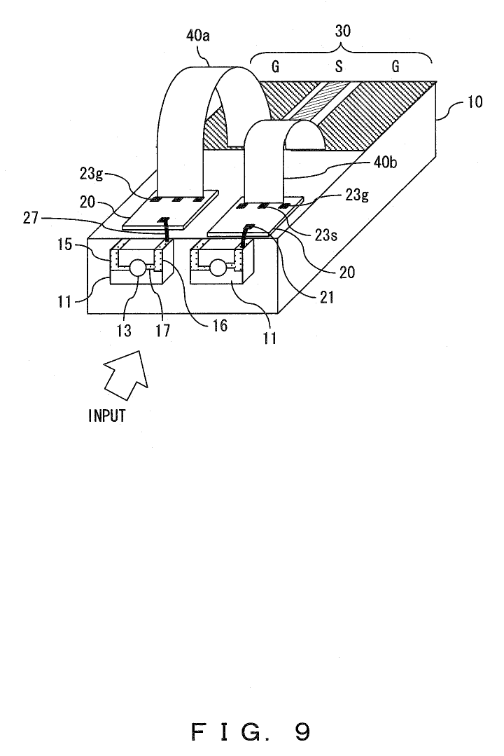

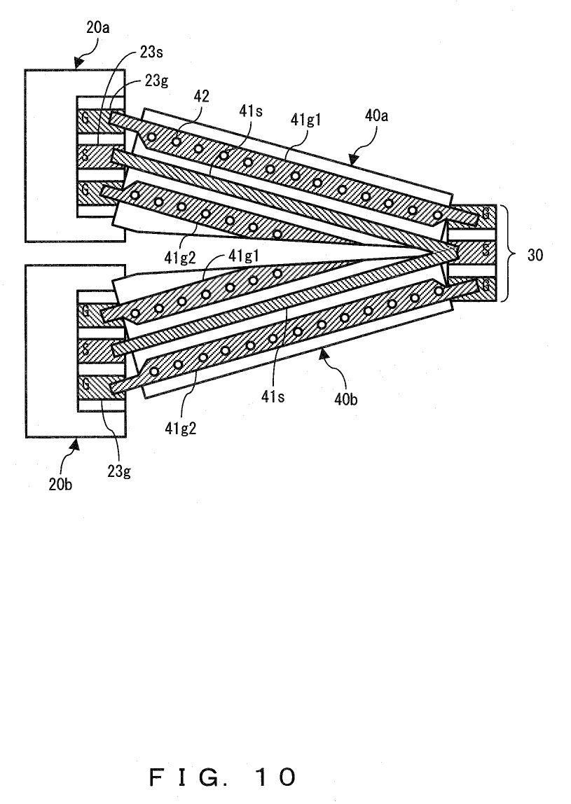

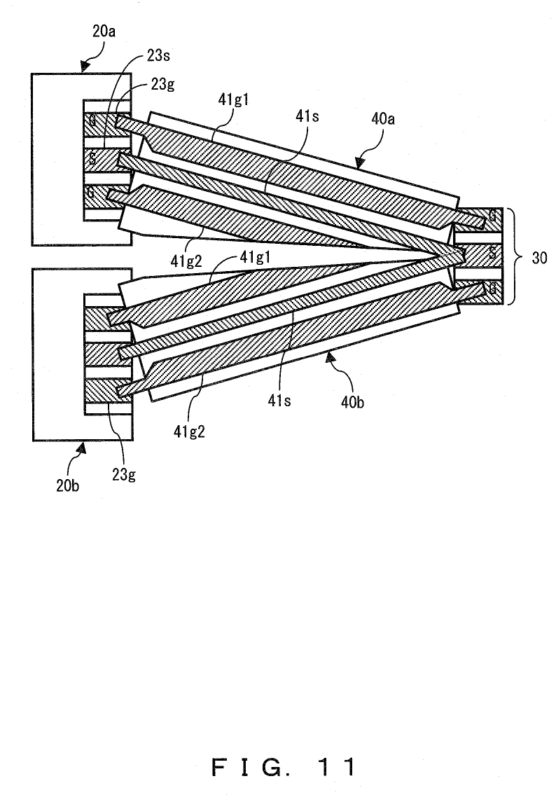

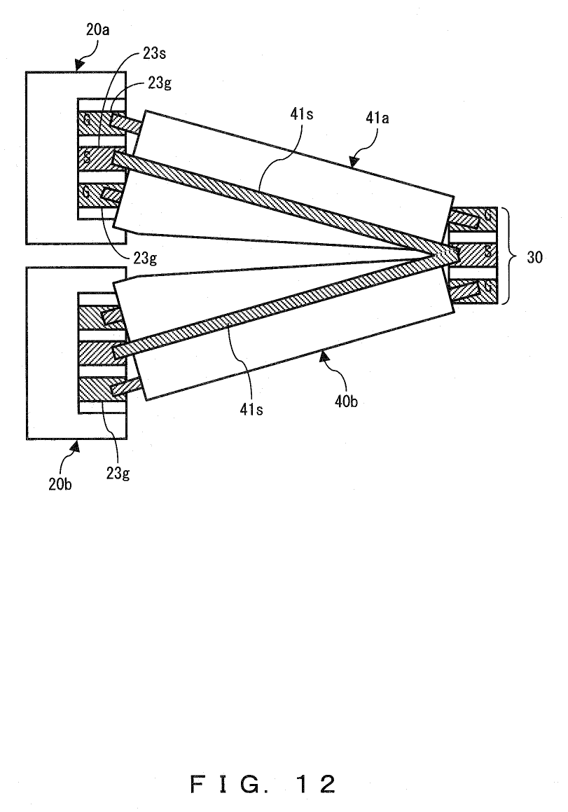

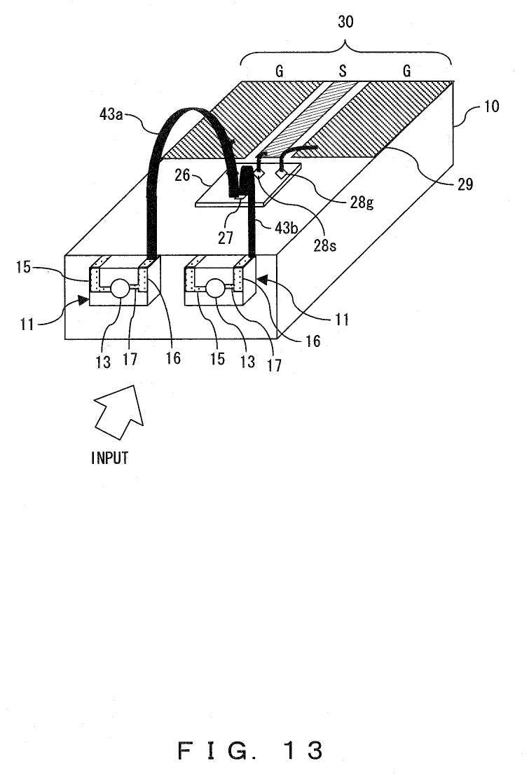

FIG. 9 shows the structure of a preferred embodiment obtained by applying the present invention to photo detector module shown in FIG. 4. In the photo detector module shown in FIG. 9, a CDR circuit is omitted. The same reference numerals are attached to the same components.

The photo detector module of this preferred embodiment is applicable to a DBPSK optical receiver or a DQPSK optical receiver. In the cases of the DBPSK and DQPSK optical receivers, one and two optical receiver modules, respectively, are mounted.

On the upper front surface of a substrate 10, a pair of surface input type PIN photodiodes 11 is longitudinally provided in an opposed manner. At front center of the PIN photodiode 11, a photo acceptance surface 13 is provided.

On the front and top surfaces of the PIN photodiode 11, an anode terminal 15 and a cathode terminal 16 are provided on the right and left side, respectively. The cathode electrode, which is not shown in FIG. 9, of the PIN photodiode 11 is connected to the cathode terminal 16 by a wire 17 on the front surface of the PIN photodiode 11. The anode terminal 15 is connected to the anode electrode, which is not shown in FIG. 9, of the PIN photodiode 11.

On the front surface of the substrate 10, a pair of electrical amplifiers 20 is longitudinally mounted almost in parallel. On the rear surface of the substrate 10, a coplanar waveguide 30 with wiring patterns of a first ground line (G), a signal line (S) and a second ground line (G) is formed.

On the front surface of the electric amplifier 20, an input terminal 21 is provided, and on the rear surface, a pair of ground terminals 23g and an output terminal 23s is provided. The output terminal 23 is disposed at the center and one of the pair of ground terminals 23g is disposed on each side. The input terminal 21 of the electrical amplifier 20 is connected to the cathode terminal 16 of the PIN photodiode 11 by a wire 27.

The output terminal 23s and the pair of ground terminals 23g of the electrical amplifier 20 on the left side (facing FIG. 9) are connected to the coplanar waveguide 30 via a first flexible substrate 40a. Similarly the electrical amplifier 20 on the right side (facing FIG. 9) is connected to the coplanar waveguide 30 via a second flexible substrate 40b.

In this preferred embodiment, although the cathode electrode of the photo acceptance surface 13 is connected to the input terminal of the electrical amplifier 20, the anode electrode of the photo acceptance surface 13 can also connected to the input terminal of the electrical amplifier 20. This also applies to preferred embodiments described later.

Next, the respective structures of the first and second flexible substrates 40a and 40b are described.

{The First Structure of the Flexible Substrate}

FIG. 10 shows the first structure of the first and second flexible substrate shown in FIG. 9. In FIG. 10, the electrical amplifier 20 on the left side (facing FIG. 10) and that on the right side (facing FIG. 10) correspond to electrical amplifiers 20a and 20b, respectively. This also applies to FIGS. 11 and 12.

Each of the first and second flexible substrates 40a and 40b has a grounded coplanar waveguide. On the surface, a pair of ground lines 41g1 and 41g2 is formed on the side and a signal line 41s is formed between the ground lines. On the entire rear side, a ground layer, which is not shown in FIG. 10, is formed. The first and second ground lines 41g1 and 41g2 are connected to the ground layer via a through hole 42.

The respective structures of the grounded coplanar waveguides of the first and second flexible substrate 40a and 40b are bisymmetrical.

On the first flexible substrate 40a, although the first ground line 41g1 is entirely longitudinally formed, the second ground line 41g2 is longitudinally formed up to almost center. Similarly, the signal line 41s of the first flexible substrate 40a is entirely longitudinally formed.

On the second flexible substrate 40b, although the second ground line 41g2 is entirely longitudinally formed, the first ground line 41g1 is longitudinally formed up to almost center. Similarly the signal line 41s of the first flexible substrate 40a is entirely longitudinally formed.

The two terminals provided on the rear surface of the first electrical amplifier 20a (the ground terminal 23g and output terminal 23s on the left (facing FIG. 10) and the two lines of the coplanar waveguide 30 (the ground line (G) and signal line (S) on the left (facing FIG. 10) are connected by the grounded coplanar waveguide formed on the first flexible substrate 40a. Similarly the two terminals provided on the rear surface of the second electrical amplifier 20a (the ground terminal 23g and output terminal 23s on the left (facing FIG. 10) and the two line of the coplanar waveguide 30 (the ground line (G) and signal line (S) on the left (facing FIG. 10) are connected by the grounded coplanar waveguide formed on the first flexible substrate 40b.

More specifically, the output terminals 23g of the first and second electrical amplifier 20a and 20b are connected to the signal line (S) of the coplanar waveguide 30 via the signal lines 41s formed on the first and second flexible substrates 40a and 40b, respectively. Respective ends of the signal line 41s of the first flexible substrates 40a and 40b are both connected to the front end of the signal line (S) of the coplanar waveguide 30.

Thus, in this preferred embodiment, combination is performed at the front end of the signal line (S) of the coplanar waveguide 30 where the respective signal lines 41s of the first and second flexible substrate 40a and 40b are connected.

In this preferred embodiment, the respective lengths of the first and second flexible substrates 40a and 40b are determined in such away that the delay difference in the combination point between the first electrical signal flowing through the signal line 41s of the first flexible substrate 40a and the second electrical signal flowing through the signal line 41s of the second flexible substrate 40b may be ps.

These lengths are experimentally determined, for example, by preparing a plurality of flexible substrates each with a different length, actually manufacturing a (CS)RZ-DQPSK or (CS)RZ-DBPSK receiver and measuring the difference (delay different) between a time until a DQPSK- (or DBPSK-) modulated optical signal is outputted from the output terminal 23s of the first electrical amplifier 20a on the left (facing FIG. 10) as an electrical signal after it is inputted to the (CS)RZ-DQPSK (or DBPSK) receiver and a time until a DQPSK- (or DBPSK-) modulated optical signal is outputted from the output terminal 23s of the second electrical amplifier 20a on the left (facing FIG. 10) as an electrical signal after it is inputted to the (CS)RZ-DQPSK (or DBPSK). For example, alternatively, the respective lengths of the first and second flexible substrate 40a and 40b can be appropriately estimated by generating a circuit model that is generated based on the design data, and test data of each component constituting a (CS)RZ-DQPSK (or DBPSK) receiver and predicting the delay difference by conducting a simulation using the circuit model.

Thus, by determining the respective lengths of the first and second flexible substrate 40a and 40b and matching their delay times when combining them, the following effects can be obtained.
(1) A 50-ohm transmission line can be formed.
(2) Since wiring lengths can be processed with accuracy of several tens of μm, delay can be compensated for in units of ps (pico-second).
(3) Insertion loss is 0.05 dB/mm or less and sufficiently small.
(4) Since a flexible substrate can be manufactured using a mask and a metal mold, a variety of products can be manufactured at low costs.
   {The Second Structure of the Flexible Substrate}

FIG. 11 shows the second structure of the first and second flexible substrates 40a and 40b shown in FIG. 9.

Each of the first and second flexible substrates 40a and 40b shown in FIG. 11 has a coplanar waveguide. This coplanar waveguide comprises a pair of ground lines 41g1 and 41g2 formed on the surface side of the first or second flexible substrate 40a and 40b and one signal line 41s formed between them. A ground layer is not formed on the rear side of the first or second flexible substrate 40a or 40b. Therefore, no through hole is formed for the ground lines 41g.

On each of the first and second flexible substrates 40a and 40b of the structure, the respective output terminal 23s of the first and second electrical amplifiers 20a and 20b and the signal line (S) of the coplanar waveguide 30 are connected via the coplanar waveguide. Since this connection is the same as in the flexible substrates 40a and 40b in the first structure, its detailed description is omitted here.

On each of the flexible substrates 40a and 40b in the second structure too, combination is performed at the front end of the signal line (S) of the coplanar waveguide 30 to which the signal line 41s of the coplanar waveguide of the first and second flexible substrates 40a and 40b are connected, as in the flexible substrates 40a and 40b in the first structure.

The respective lengths of the flexible substrates 40a and 40b in the second structure are also approximately determined in the same way as in the flexible substrate 40a and 40b in the first structure. By using the flexible substrates 40a and 40b in the first structure too, the above-described effects (1)-(4) can be obtained.

{The Third Structure of the Flexible Substrate}

FIG. 12 shows the third structure of the first and second flexible substrates 40a and 40b shown in FIG. 9.

Each of the first and second flexible substrates 40a and 40b shown in FIG. 12 has a micro split line. This micro split line comprises a signal line 41s formed on the first or second flexible substrate 40a or 40b and a ground layer, which is not shown in FIG. 12, formed on the entire rear side.

On each of the first and second flexible substrates 40a and 40b, the signal line 41s of the micro split line is connected to the output terminal 23s of the first or second electrical amplifier 20a or 20b and the signal line (S) of the coplanar waveguide 30. The ground layer of the micro split line is connected to the pair of ground terminals 23g of the first or second electrical amplifier 20a or 20b via a pair of lead units, and is also connected to the ground line (G) of the coplanar waveguide 30 via one lead unit.

In this way, the respective output terminals 23s of the first and second electrical amplifiers 20a and 20b and the signal line (S) of the coplanar waveguide 30 via the signal line 41s of the micro split line formed on the first and second flexible substrates 40a and 40b. Combination is performed at the front end of the signal line (S) of the coplanar waveguide 30 to which the respective signal line s 41s of both flexible substrates as in the first and second flexible substrates 40a and 40b in the first or second structure.

The respective lengths of the first and second flexible substrates 40a and 40b with this micro split line can be appropriately determined in the same way as in the first and second flexible substrates 40a and 40b in the first or second structure.

By using the first and second flexible substrates 40a and 40b in the third structure, the above-described effects (1)-(4) can be obtained.

### The Second Preferred Embodiment

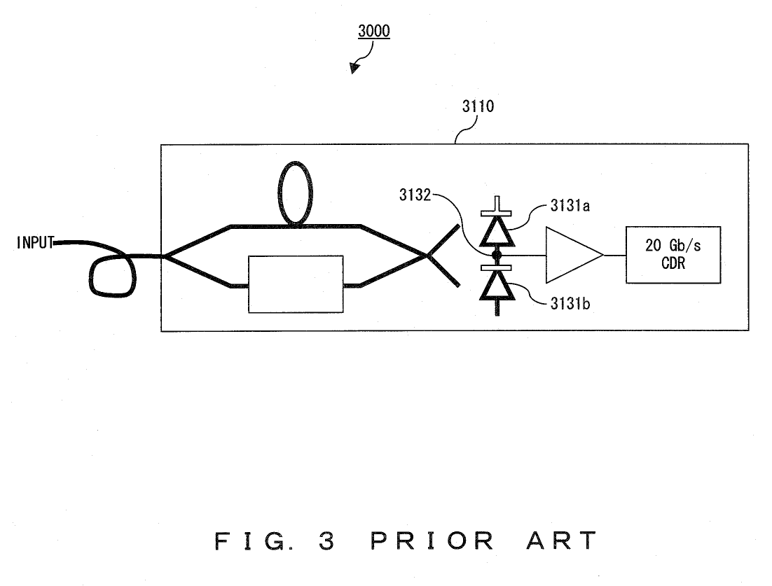

FIG. 13 shows the structure of the preferred embodiment obtained by applying the present invention to photo detector module shown in FIG. 2 or 3. In the photo detector module shown in FIG. 13, the same reference numerals are attached to the same components as in FIG. 9 and their detailed descriptions are omitted here.

The photo detector module of this preferred embodiment is applicable to DBPSK and DQPSK optical receivers. In the cases of DBPSK and DQPSK optical receivers, one and two of the photo detector module, respectively, are mounted.

The cathode terminal 16 of the PIN photodiode 11 provided on the upper left front (facing FIG. 12) of the substrate 10 is connected to the input terminal 27 of an electric amplifier 26 by the first flexible substrate 43a. The cathode terminal 16 of the PIN photodiode 11 provided on the upper right front (facing FIG. 12) of the substrate 10 is connected to the input terminal 27 of an electric amplifier 26 by the second flexible substrate 43b. Therefore, in this preferred embodiment, combination is performed at the input terminal 27 of the electrical amplifier 26 where the signal line of the first flexible substrate 43a, which is not shown FIG. 13, and the signal line terminal 16 of the second flexible substrate 43b, which is not shown FIG. 13, are connected. A pair of ground terminals 28g and output terminal 28s of the electrical amplifier 26 are connected to a pair of ground lines (G) and signal line (s) of the coplanar waveguide 30 via a wire 29.

In this preferred embodiment too, the respective lengths of the first and second flexible substrates 40a and 40b are determined in such away that the delay difference in the combination point between the first electrical signal flowing through the signal line 41s of the first flexible substrate 40a and the second electrical signal flowing through the signal line 41s of the second flexible substrate 40b may be ps in almost the same way as in the first preferred embodiment.

Specifically, these lengths are experimentally determined by preparing a plurality of flexible substrates each with a different length, actually manufacturing a (CS)RZ-DQPSK or (CS)RZ-DBPSK receiver and measuring the difference (delay different) between a first time until a DQPSK- (or DBPSK-) modulated optical signal is outputted from the termination end of the cathode terminal 16 of the PIN photodiode 11 on the left as a first electrical signal after it is inputted to the (CS)RZ-DQPSK (or DBPSK) receiver and a second time until a DQPSK- (or DBPSK-) modulated optical signal is outputted from termination end of the cathode terminal 16 of the PIN photodiode 11 on the right as a second electrical signal after it is inputted to the (CS)RZ-DQPSK (or DBPSK) receiver. Alternatively, as in the first preferred embodiment, the respective lengths of the first and second flexible substrates 43a and 43b can be appropriately estimated by conducting a simulation using the circuit model by conducting a simulation using the circuit model and predicting the delay difference.

On the first and second flexible substrates 43a and 43b in this preferred embodiment too, a transmission line in one of the forms of a grounded coplanar waveguide, a coplanar waveguide or a micro strip line can be formed, as in the first and second flexible substrates 40a and 40b in the first preferred embodiment.

Since this preferred embodiment uses the first and second flexible substrates 43a and 43b to connect the PIN photodiode 11 and the electric amplifier 26, compared with the conventional structure using a wire to connect them, the wiring length between the PIN photodiode 11 and the electric amplifier 26 can be easily extended and also adjusted.

### The Third Preferred Embodiment

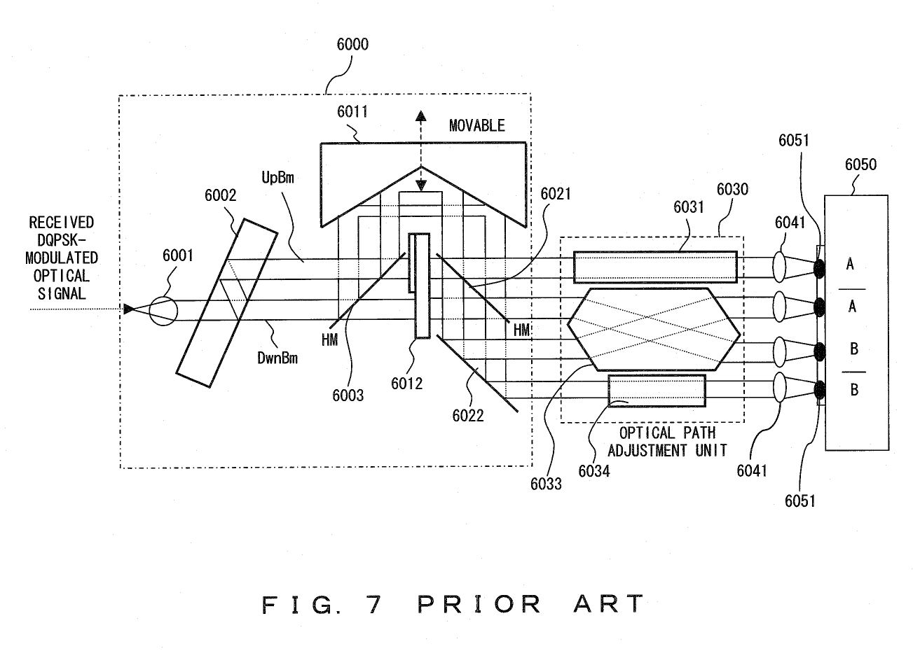

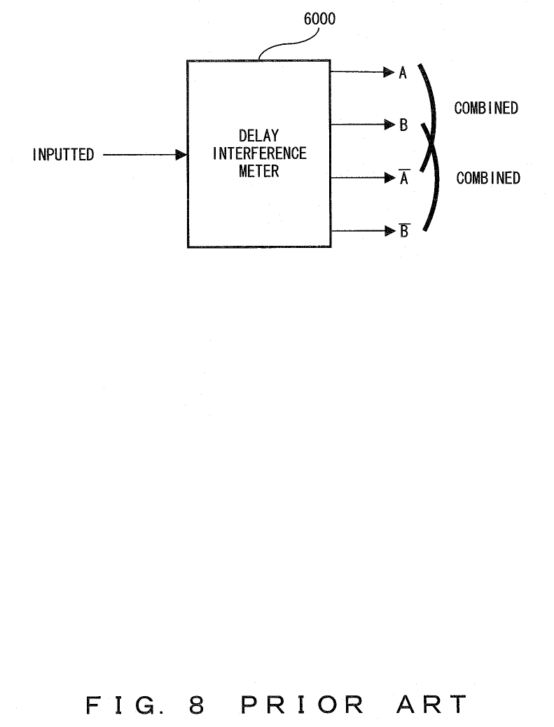

In the third preferred embodiment, the present invention is applied to a DQPSK receiver with the delay interferometer shown in FIG. 7. Optical signals which are outputted from the delay interferometer shown in FIG. 7 and are demodulated are arrayed in order of an optical signal A, an optical signal B, a complementary optical signal A and a complementary optical signal B. Therefore, if no optical path length adjustment unit shown in FIG. 8 is provided between the delay interferometer and a balanced receiver, (optical signals A and B) and (complementary optical signals A and B) are inputted to two pairs of differential photo detectors of the balanced receiver.

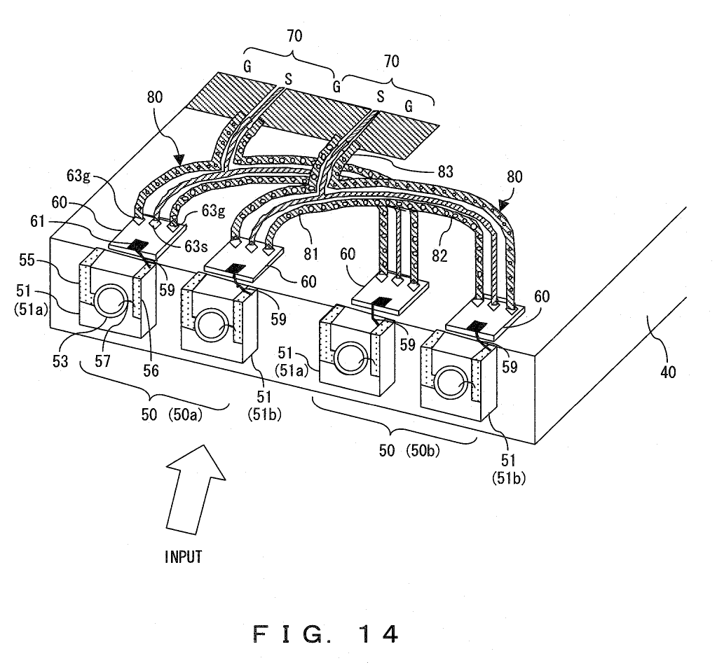

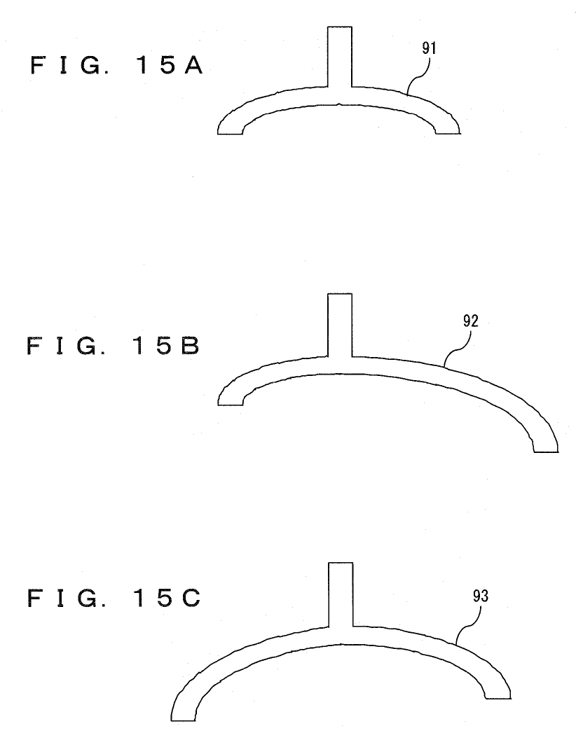

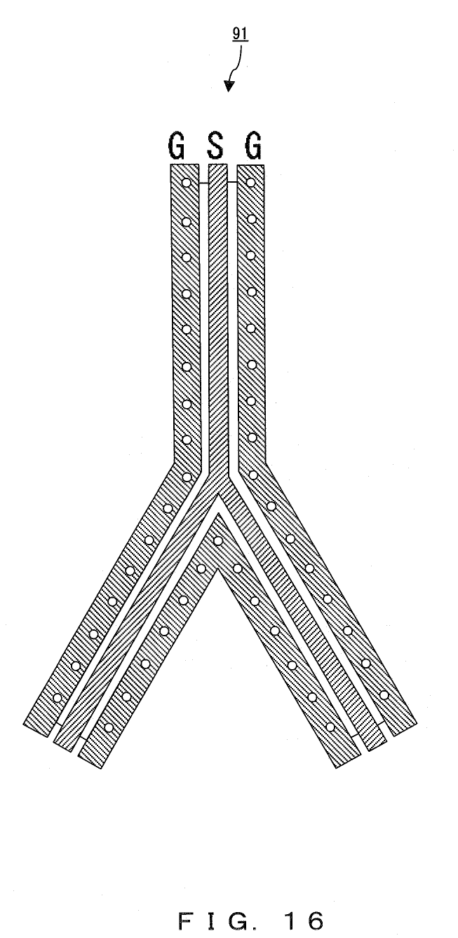

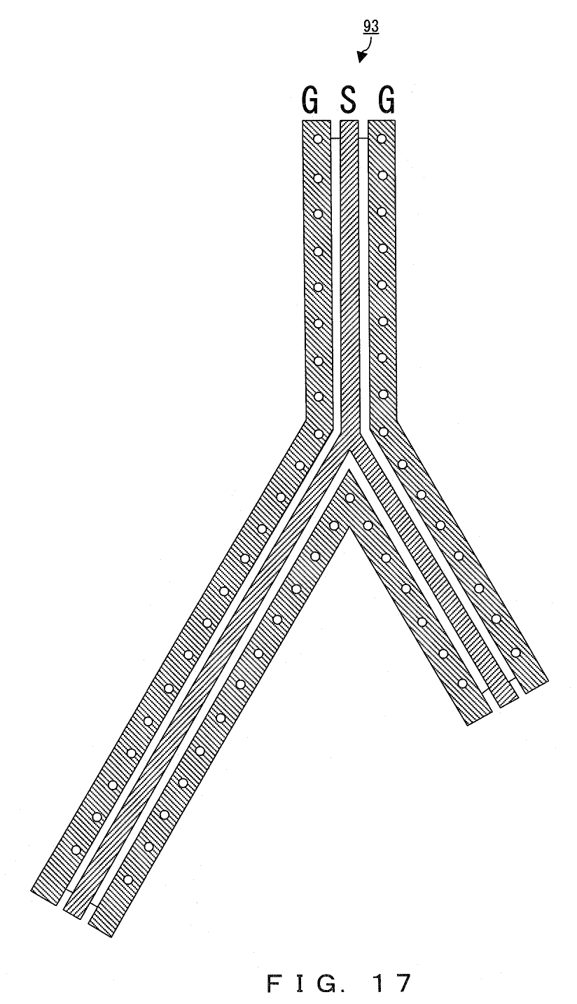

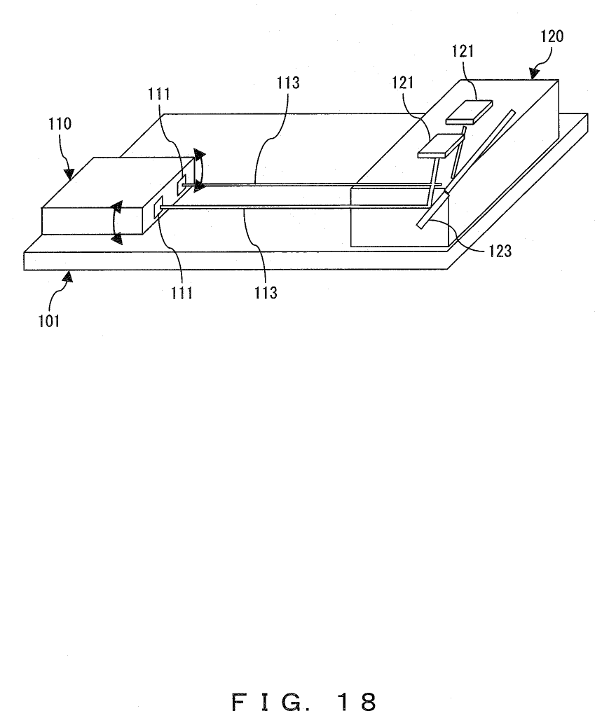

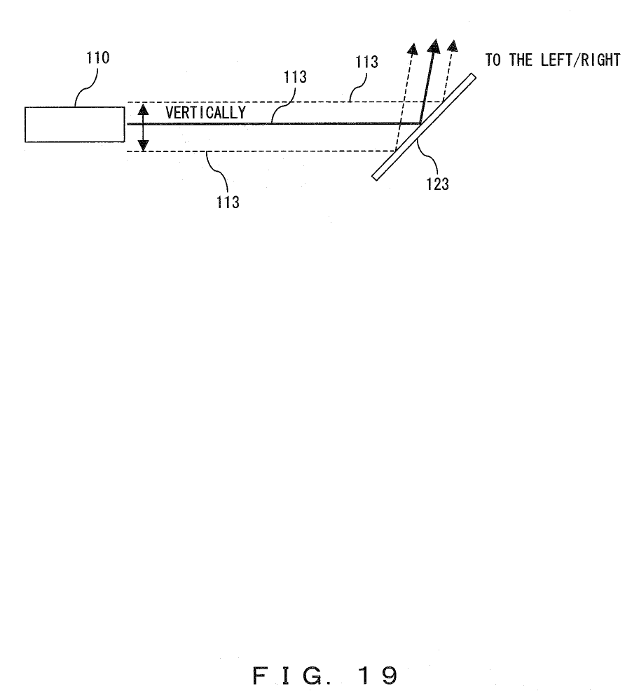

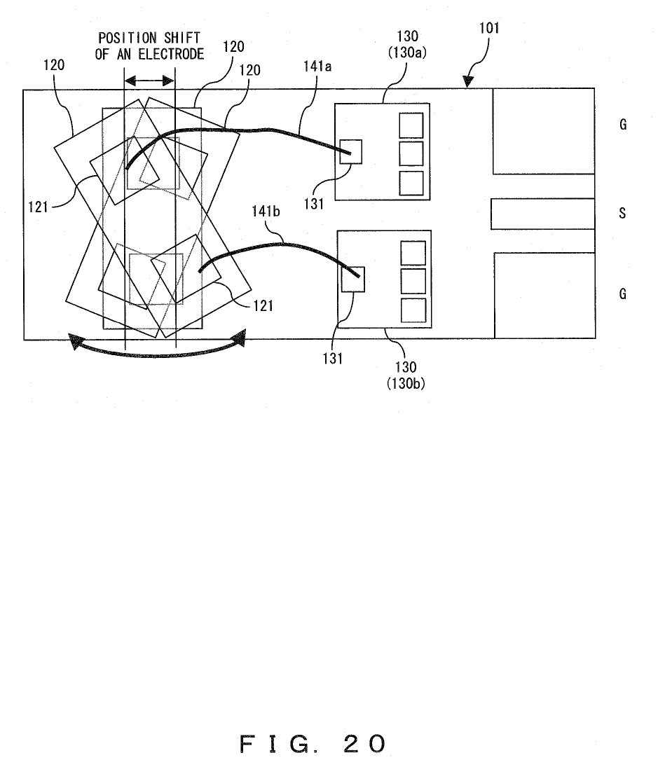

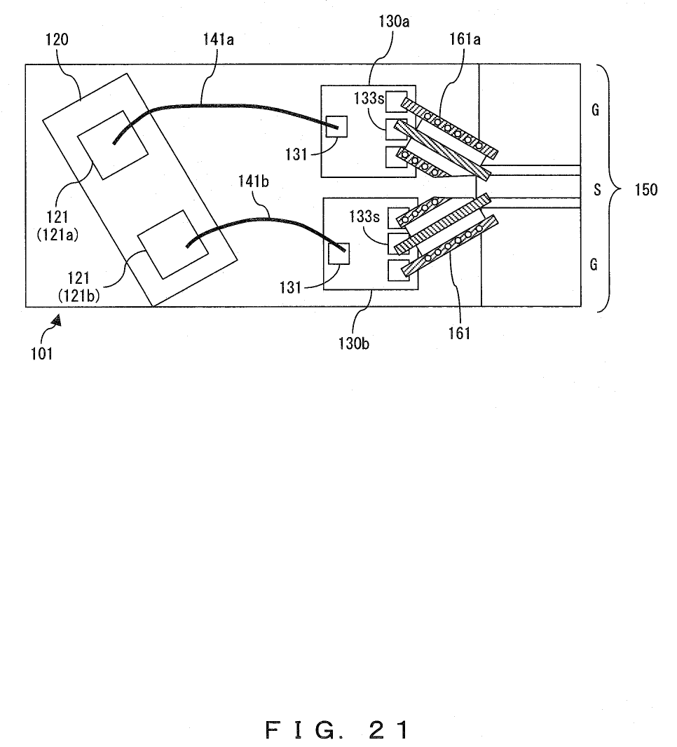

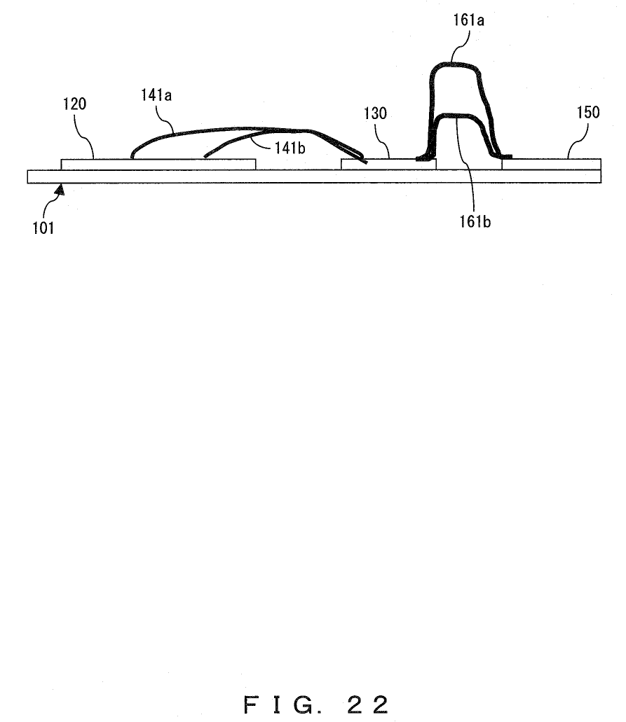

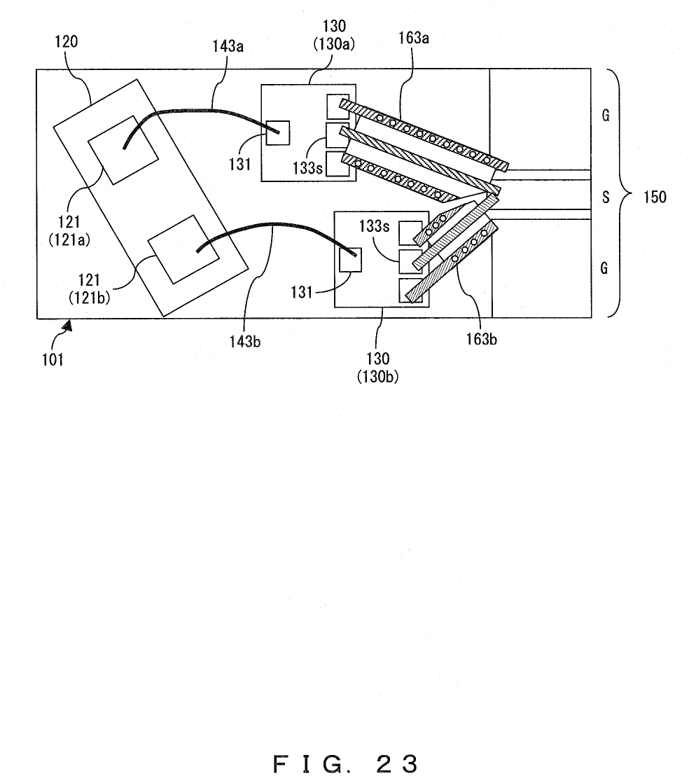

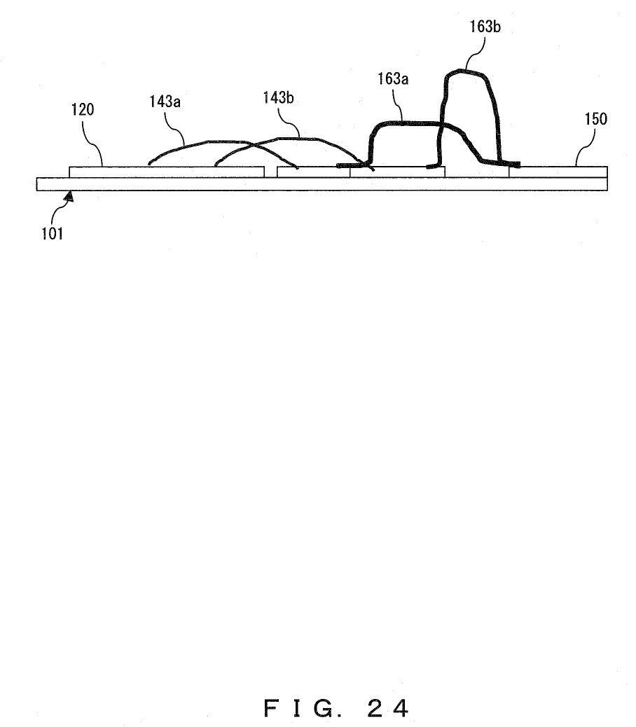

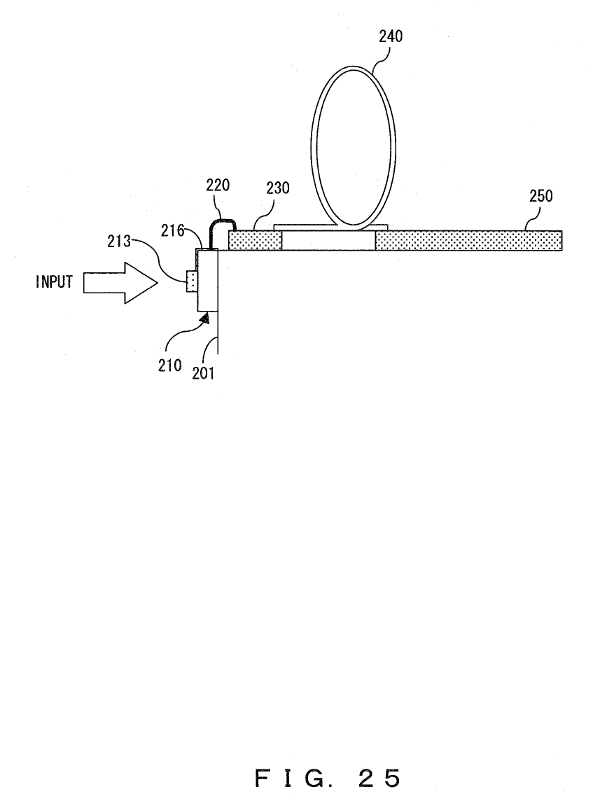

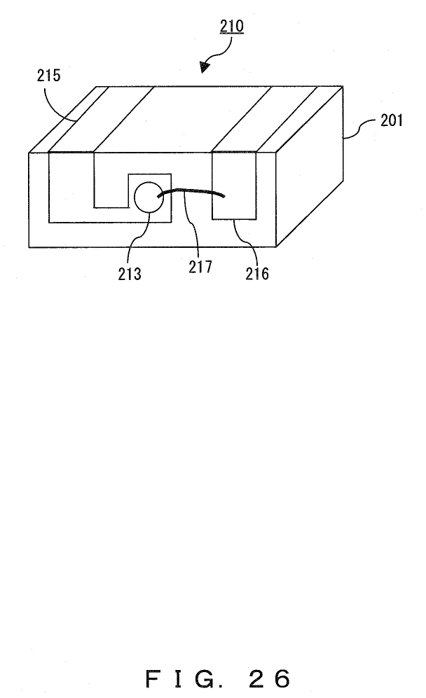

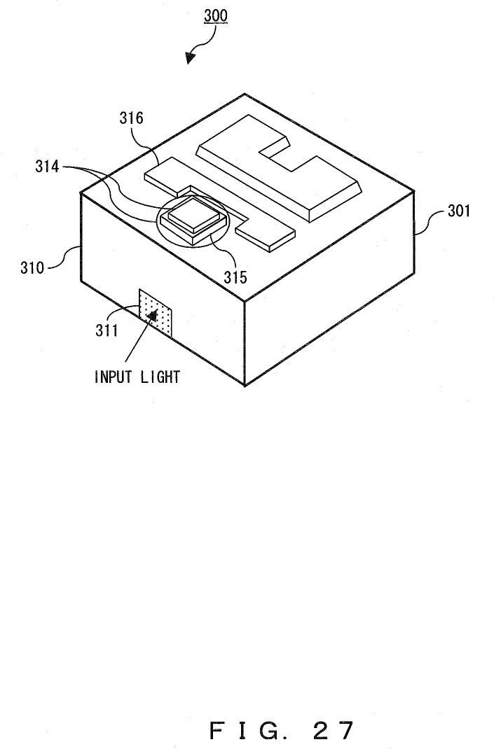

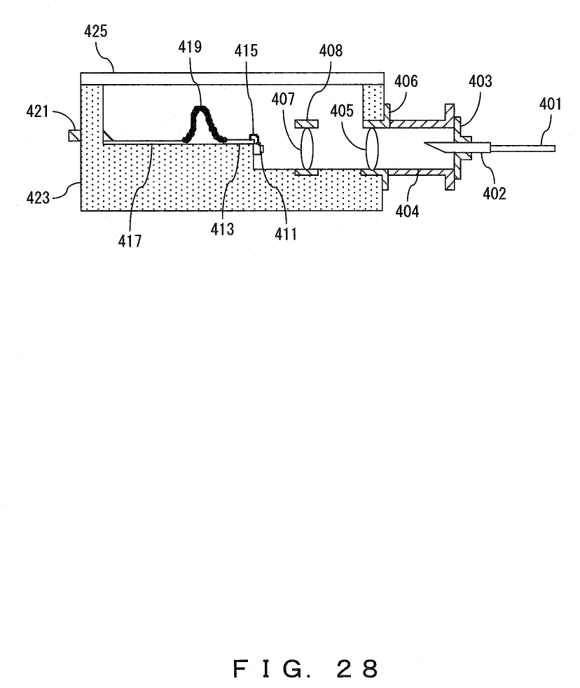

FIG. 14 shows the major structure of a photo detector module suited to be used in combination with a delay interferometer for outputting optical signals arranged as shown in FIG. 8.

The photo detector module shown in FIG. 14 comprises a module substrate 40, a pair of photoelectrical conversion units 50, four electrical amplifiers 60, a pair of coplanar waveguides 70 and a pair of flexible substrates 80, which are all mounted on the module substrate.

The pair of photoelectric conversion units 50 (50a and 50b) is provided on the front surface of the module substrate 40. Each of the pair of photoelectric conversion units 50 comprises two PIN photodiodes 51 longitudinally provided in parallel.

The pair of photoelectric conversion units 50a on the left (facing FIG. 14) comprises a pair of PIN photodiodes 51 (51a and 51b) longitudinally provided in parallel. The PIN photodiode 51a converts the optical signal A into the first electrical signal A, and the PIN photodiode 51b converts the complementary optical signal A into the second electrical signal A.

The pair of photoelectric conversion units 50b on the right (facing FIG. 14) has the same structure as the pair of photoelectric conversion units 50a, and converts the optical signal B and complementary optical signal B into the first and second electrical signals by the PIN photodiode 51a on the left (facing FIG. 14) and the PIN photodiode 51b on the right facing FIG. 14), respectively.

At the center of the PIN photodiode 51, a photo acceptance surface 53 is provided. On the left and right (facing FIG. 14), a cathode terminal 55 and an anode terminal 56, respectively, are formed. The cathode terminal 55 and anode terminal 56 are expanded and formed at the left and right ends, respectively, of the upper side surface of the PIN photodiode 51. The cathode terminal 55 is connected to the anode electrode, which is not shown in FIG. 14, of the PIN photodiode 51. The anode terminal 56 is connected to the cathode electrode, which is not shown in FIG. 14, of the PIN photodiode 51 via a wire 57.

On the front surface of the module substrate 40, four electric amplifiers 60 are provided in parallel in correspondence with each PIN photodiode 51 of the pair of photoelectric conversion units 50.

At the center of the front end of the surface unit of the electric amplifier 60, an input terminal 61 is provided. At each rear end of the surface unit, a pair of ground terminals 63g is provided, and between the ground terminals 63g, an output terminal 63s is provided. The input terminal 61 of the electric amplifier 60 is connected to the anode terminal 56 of a corresponding PIN photodiode 51 by a wire 59.

The flexible substrate 80 has a shape of an almost Y character and is branched into two at the center. Therefore, the flexible substrate 80 comprises a pair of branching units 81 and 82 constituting an almost V character shape and one straight line unit 83. On each of the branching units 81-83, a grounded coplanar waveguide is formed. The respective grounded coplanar waveguides of the pair of the branching units 81 and 82 join at their connecting region and are connected to the grounded coplanar waveguide of the straight line unit 83 at the joining region.

The grounded coplanar waveguide of the flexible substrate 80 on the left (facing FIG. 14) connects the respective pair of ground terminals and output terminals of the first and third electric amplifiers 60 from the left end, and the pair of ground lines G and signal line S of the coplanar waveguide on the left (facing FIG. 14) formed on the rear surface of the module substrate 40. The grounded coplanar waveguide of the flexible substrate 80 on the right (facing FIG. 14) connects the respective pair of ground terminals and output terminals of the second and fourth electric amplifiers 60 from the left end, and the pair of ground lines G and signal line S of the coplanar waveguide on the left (facing FIG. 14) formed on the rear surface of the module substrate 40.

In the photo detector module so structured, the optical signals A and B outputted from the delay interferometer, which is not shown in FIG. 14, are converted into the first electrical signals A and B by the PIN photodiode 51 of the photoelectric conversion unit 50 on the left (facing FIG. 14) and are inputted to the input terminals 61 of the first and second electric amplifiers 60, respectively, from the left end via the wire 59. The complementary optical signals A and B outputted from the delay interferometer are converted into the second electrical signals A and B by the PIN photodiode 51 of the photoelectric conversion unit 50 on the right (facing FIG. 14) and are inputted to the input terminals 61 of the third and fourth electric amplifiers 60 from the left end, respectively, via the wire 59.

The first electrical signal A and second electrical signal A that are amplified by the first and third electrical amplifiers 60, respectively, from the left end are combined at the joining member of the flexible substrate 80 on the right (facing FIG. 14). The first electrical signal B and second electrical signal B that are amplified by the second and fourth electrical amplifiers 60, respectively, from the left end are combined at the joining region of the flexible substrate 80 on the right (facing FIG. 14).

As described above, according to the photo detector module of this preferred embodiment, the optical signals A and B and complementary optical signals A and B which are outputted from the delay interferometer 500 shown in FIG. 7 are converted into the first electrical signals A and B and second electrical signals A and B, respectively, by the pair of photoelectric conversion units 50 and are amplified by the electric amplifiers 60. Then, the first electrical signal A and second electrical signal A can be combined at the joining member of the flexible substrate 80 on the left (facing FIG. 14), and the first electrical signal B and second electrical signal B can be combined at the joining region of the flexible substrate 80 on the right (facing FIG. 14).

FIGS. 15A-15C show various shapes of flexible substrates used in this preferred embodiment. In the flexible substrate 91 shown in FIG. 15A, the respective shapes of its left and right branching units are the same. The flexible substrate 91 can also have a grounded coplanar waveguide or coplanar waveguide, for example, shown in FIG. 16.

In the flexible substrate 92 shown in FIG. 15B, its branching unit on the right (facing FIG. 15B) is longer than that on the left (facing FIG. 15B). In the flexible substrate 93 shown in FIG. 15C, its branching unit on the left (facing FIG. 15C) is longer than that on the right (facing FIG. 15C). As shown in FIG. 15C, the flexible substrate 93 can also have a grounded coplanar waveguide or a coplanar waveguide. The flexible substrate 92 can also have a grounded coplanar waveguide or a coplanar waveguide like the flexible substrates 91 and 92, which is not especially shown in FIG. 15C. Each of the flexible substrates 91-93 can also have a micro split line. Furthermore, the respective transmission line structures of the branching units 81 and 82 and straight line unit 83 of the flexible substrate 80 cannot also be unified and each of the units can also have one of a grounded coplanar waveguide, a coplanar waveguide and micro split line. In such a structure, the combination of the respective transmission line structures of the units can take various combinations of the grounded coplanar waveguide, coplanar waveguide and micro split line.

Although in FIGS. 16 and 17, each of the branching units of the flexible substrates 91 and 93 has a straight line shape, they are only one example. The respective branching units of the flexible substrates 91 and 93 shown in FIGS. 16 and 17, respectively, are not limited to a straight line shape, and they can also have a curved line shape.

In this preferred embodiment, by measuring the delay difference at the output terminal 63 of the electric amplifier 60 and selecting an appropriate shape from the shapes of the flexible substrate, shown in FIGS. 15A-C, the above-described effects (1)-(4) can be obtained.

### The Fourth Preferred Embodiment

FIG. 18 shows the structure of a photo detector module adopting a photoelectric conversion unit provided with an side illuminated Mirror type PIN photodiode.

The photo detector module of this preferred embodiment is applicable to DBPSK and DQPSK optical receivers, and in the cases of the DBPSK and DQPSK optical receivers, one and two, respectively, are mounted.

The photo detector module shown in FIG. 18 comprises a delay interferometer 110 and a photoelectric conversion unit 120 which are mounted on a substrate 101. The photo detector module receives an optical signal 113 outputted from a pair of light output units 111 of the delay interferometer 110 on the front surface of the photoelectric conversion unit 120.

The photoelectric conversion unit 120 comprises a 45-degree inclined mirror 123. The photoelectric conversion unit 120 reflects an optical signal inputted from the delay interferometer 110 on the mirror 123 and inputs it to the photo acceptance unit, which is not shown in FIG. 18, of a pair of PIN photodiodes 121 provided on the top surface of the photoelectric conversion unit 120. The PIN photodiode 121 converts/outputs the inputted optical signal into an electrical signal.

FIG. 19 typically shows a first problem caused in the photo detector module structured as shown in FIG. 18.

Although the delay interferometer 110 is fixed on the substrate 101 by adhesive, the delay interferometer 110 is tilted if there is unevenness in the thickness of the adhesive. As shown in FIG. 18, the optical signal outputted from the light output unit 111 of the delay interferometer 110 is vertically shifted by the tilt. The optical path of the optical signal reflected on the mirror 123 is horizontally shifted by the shift to cause inconvenience that the optical signal cannot be correctly inputted to the photo acceptance unit of the PIN photodiode 121. Therefore, when mounting the PIN photodiode 121, its position must be adjusted.

FIG. 20 typically shows a new problem caused by solving the first problem by compensation. In order to solve a problem caused by the tilt of the delay interferometer 110 by the photoelectric conversion unit 120, the position of the PIN photodiode 121 of the photoelectric conversion unit 120 must be adjusted. In order to adjust the position, the photoelectric conversion unit 120 must be horizontally rotated and disposed.

When the direction of the photoelectric conversion unit 120 which should be essentially provided perpendicularly to the longitudinal direction of the substrate 101 is horizontally rotated, the position of the PIN photodiode 121 provided for the photoelectric conversion unit 120 is horizontally rotated and the position of its electrode is horizontally deviated.

Thus, the respective lengths of wires 143a and 143b must be adjusted in order to match the delay times of signals to be combined. However, since, as described earlier, the influence of wire bonding on its high frequency characteristic is great, the adjustment of wire length cannot be applied to a photo detector module for receiving high bit rate optical signals.

{The First Structure for Compensation by the Flexible Substrate}

FIG. 21 is the top views of the first structure of the flexible substrate in which the location of the photoelectric conversion unit is inclined to the left in order to compensate for influences due to the tilt of the delay interferometer. FIG. 22 is its side view.

As shown in FIG. 21, if the photoelectric conversion unit 120 is inclined to the left from its essential position and is disposed, the respective longitudinal positions on the substrate 101, of the PIN photodiode 121a on the left (upper in FIG. 21) and PIN photodiode 121b on the right (facing FIG. 21) of the photoelectric conversion unit 120 become different. Therefore, if the respective locations on the substrate 101 of electrical amplifiers 130a and 130b are not modified, the length of a wire 141a for connecting the electrode (cathode or anode electrode) of the PIN photodiode 121a and the input terminal 131 of the electrical amplifier 130a and that of a wire 141b for connecting the electrode (cathode or anode electrode) of the PIN photodiode 121b and the input terminal 131 of the electrical amplifier 130b differ, and the wire 141a becomes longer than the wire 141b.

Therefore, in this structure, by connecting the output terminals 133s of the first and second electrical amplifiers 130a and 130b and the signal line (S) of the coplanar waveguide 150 by the first and second flexible substrates 161a and 161b, respectively, and adjusting the respective lengths of the first and second flexible substrates 161a and 161b, as shown in FIG. 22, their delay times can be matched when they are combined. The respective lengths of the first and second flexible substrates 161a and 161b are determined as in the first preferred embodiment.

For the respective transmission lines of the first and second flexible substrates 161a and 161b, a coplanar waveguide or a micro split line can also be used instead of the grounded coplanar waveguide shown in FIG. 21.

{The Second Structure for Compensation by the Flexible Substrate}

FIG. 23 is the top views of the second structure of the flexible substrate in which the location of the photoelectric conversion unit is inclined to the left in order to compensate for influences due to the tilt of the delay interferometer. FIG. 24 is its side view.

As described above, if the photoelectric conversion unit 120 is inclined to the left from the essential position, the respective longitudinal positions on the substrate 101, of the PIN photodiode 121a on the left (upper in FIG. 21) and PIN photodiode 121b on the right (facing FIG. 21) of the photoelectric conversion unit 120 become different. In the structures shown in FIGS. 23 and 24, the respective locations on the substrate 102, of the first and second electrical amplifiers 130a and 130b are adjusted in such a way the length of a wire 141a for connecting the electrode (cathode or anode electrode) of the PIN photodiode 121a and the input terminal 131 of the electrical amplifier 130a and that of a wire 141b for connecting the electrode (cathode or anode electrode) of the PIN photodiode 121b and the input terminal 131 of the electrical amplifier 130b may become equal.

As a result, in this structure, the distance between the first electrical amplifier 130a and the coplanar waveguide 150 and that between the second electrical amplifier 130b and the coplanar waveguide 150 differ. In this structure, as shown in FIGS. 15 and 16, the respective output terminals 133s of the first and second electrical amplifiers 130a and 130b and the signal line (S) of the coplanar waveguide 150 are connected by the first and second flexible substrates 163a and 163b, respectively, and as shown as FIGS. 23 and 24, by adjusting the respective lengths of the first and second flexible substrates 163a and 163b, their delay times can be matched when they are combined. The respective lengths of the first and second flexible substrates 163a and 163b are determined as in the first preferred embodiment.

For the respective transmission lines of the first and second flexible substrates 163a and 163b, a coplanar waveguide or a micro split line can also be used instead of the grounded coplanar waveguide shown in FIG. 23.

Although in this preferred embodiment, the first electrical amplifier 130a and coplanar waveguide 150, and the second electrical amplifier 130b and coplanar waveguide 150 are connected by separate flexible substrates 163a and 163b, respectively, they can also be connected by one flexible substrate, using, for example, a Y character-shaped flexible substrate used in the third preferred embodiment.

### The Fifth Preferred Embodiment

The fifth preferred embodiment of the present invention can reduce the longitudinal length of a flexible substrate when connecting an electrical amplifier provided on the substrate and a coplanar waveguide formed on the substrate by the flexible substrate in the above-described first through fourth preferred embodiments.

FIG. 25 shows the side view of the fifth preferred embodiment.

The photo detector module shown in FIG. 25 comprises a PIN photodiode 210 provided on the front surface of a substrate, an electrical amplifier 230 and a coplanar waveguide 250, which are provided on the surface of the substrate and a flexible substrate 240 for connecting the output terminal, which is not shown in FIG. 25, of the electrical amplifier and the signal line (S) of the coplanar waveguide 250. The anode electrode, which is not shown in FIG. 25, of the PIN photodiode 210 is connected to the input terminal, which is not shown in FIG. 25, of the electrical amplifier 230 via an anode terminal 216 formed on the front surface and top surface of the PIN photodiode 210.

FIG. 26 shows the detailed structure of the PIN photodiode 210.

As shown in FIG. 26, on the front top of the substrate 201, a photo acceptance surface 213 is provided. The anode electrode, which is not shown in FIG. 26, of the PIN photodiode 210 is connected to an anode terminal 216 formed in the vicinity of the left end of the substrate 201 by a wire 217.

In this preferred embodiment, a flexible substrate 240 for connecting the electrical amplifier 230 and the coplanar waveguide 250 has a loop shape. Therefore, the longitudinal length of the flexible substrate 240 can be reduced to extend the delay time and reduce the distance between the electrical amplifier 230 and the coplanar waveguide 250. Furthermore, the photo detector module can be miniaturized.

Although in all the above-described preferred embodiments, a surface input type PIN photodiode is used as a photo acceptance device, an side illuminated Mirror type PIN photodiode as shown in FIG. 27 can also be used in the present invention.

The side illuminated Mirror type PIN photodiode 300 shown in FIG. 27 has a rectangular photo acceptance area 311 at the bottom center of the end surface 310 of the substrate 301, to which light is inputted. On the front surface of the substrate 301, a photo detector unit 314 and an anode electrode 315 are formed and laminated, and behind the photo detector unit 314, a cathode electrode 316 is formed.

At almost the center of the rear surface of the substrate, a groove in a shape of a V character is formed, which is not shown in FIG. 27, and the entire rear surface is anti-reflection (AR) coated. An optical signal inputted to the photo acceptance area 311 is reflected on the V character-shaped groove and inputted to/absorbed by the photo detector unit 314.

Although a flexible substrate has a disadvantage in moisture resitance, this disadvantage can be resolved by hermetically sealing it together with the PIN photodiode.

FIG. 28 is the section view showing the package structure of the photo detector module in each above-described preferred embodiment.

The photo detector module shown in FIG. 28 comprises a fiber (optical fiber) 401, a boot 402 for inserting/fixing the fiber 401, a first package also used as a holder for holding the boot 402, a second package fixed on the first package 403, a collimation lens 405 for converting/outputting optical signals inputted from the fiber 401 into parallel light, a first lens holder 406 fixed on the second package 404 for holding 5th collimation lens 405, a focusing lens 407 for converting/outputting the parallel light outputted from the collimation lens 405 into a light beam, a second lens holder 408 for holding the focusing lens, a PIN photodiode 411 for receiving the light beam outputted from the focusing lens 407 and converting it into an electrical signal, an electrical amplifier 413 for amplifying the electrical signal outputted from the PIN photodiode 411, a wire for connecting the electrode (anode or cathode electrode) of the PIN photodiode 411 and the electrical amplifier 413, a ceramic substrate 417 on whose surface a coplanar waveguide, which is not shown in FIG. 28, a flexible substrate 419 for connecting the electrical amplifier 413 and the coplanar waveguide on the ceramic substrate 417, an output terminal 421 connected to the signal line(S) of the coplanar waveguide, a third ceramic or metal package 423 on which the above-described components (406, 408, 411, 413, 417 and 411) are mounted and a cover 425 for covering the open space of the third package.

Inside the module covered by the first package 403, second package 404 and third package 423 and the cover 425, inert gas is contained.

Although in the above-described preferred embodiments, as a photo acceptance device, a PIN photodiode is used, another photo acceptance device, such as an avalanche photodiode (APD) or the like can also be used instead of the PIN photodiode.

The present invention is not limited to the above-described preferred embodiments, and can be variously modified as long as the subject matter of the present invention is not deviated.

Although the above-described preferred embodiments are related to the delay time adjustment of a DBPSK- or DQPSK-modulated optical signal, the present invention is applicable not only to the delay time adjustment of a DQPSK-modulated optical signal but also to that of an optical signal modulated by M phase differential phase shift keying. The present invention is not limited to a (CS)RZ-differential phase shift keying modulation receiver, and is applicable to all differential phase shift keying modulation optical receivers for demodulating an optical signal modulated by a differential phase shift keying, such as a RZ-differential phase shift keying modulation receiver or the like.

1. A delay time adjustment device for adjusting in such a way that the delay times of two branched optical signals obtained by branching a received optical signal in a delay interferometer can be matched when both branched optical signals are converted into electrical signals by a photo acceptance device and are combined after both branched optical signals interfere with each other in the delay interferometer for demodulating an optical signal modulated by differential phase shift keying, comprising:
at least one balanced receiver, wherein said balanced receiver comprises
a pair of photo acceptance devices for photoelectrically converting the two branched optical signals separately;
a pair of amplifiers provided in correspondence with the pair of photo acceptance devices, for receiving/amplifying photoelectrically converted signals outputted from a corresponding photo acceptance device; and
a flexible substrate for connecting the outputs of the pair of amplifiers and a signal line on which the photoelectrically converted signals of the two branched optical signals are combined and adjusting the delay times of the two branched optical signals when branched optical signals are combined.

2. The delay time adjustment device according to claim 1, wherein the balanced receiver comprises
a first photo acceptance device for converting one branched optical signal which must be outputted from the interferometer and must be combined into a first electrical signal;
a first electrical amplifier for amplifying and outputting the electrical signal outputted from the first photo acceptance device;
a first flexible substrate for connecting the output terminal of the first electrical amplifier and a signal line on which the combination is performed;
a second photo acceptance device for converting the other branched optical signal which must be outputted from the interferometer and must be combined into a second electrical signal;
a second electrical amplifier for amplifying and outputting the electrical signal outputted from the second photo acceptance device; and
a second flexible substrate for connecting the output terminal of the second electrical amplifier and a signal line on which the combination is performed.

3. A delay time adjustment device for adjusting in such a way that the delay times of two branched optical signals obtained by branching a received optical signal in a delay interferometer can be matched when both branched optical signals are converted into electrical signals by a photo acceptance device and are combined after both branched optical signals interfere with each other in the delay interferometer in a photo acceptance device for demodulating an optical signal modulated by differential phase shift keying, comprising:
at least one balanced receiver, wherein said balanced receiver comprises
two photo acceptance devices constituting a balanced type detector for photoelectrically converting the two branched optical signals individually; an amplifier with an input terminal to which electrical signals outputted from the two photo acceptance devices are inputted;
a first flexible substrate for connecting the terminal of one photo acceptance device and the input terminal of the amplifier; and
a second flexible substrate for connecting the terminal of the other photo acceptance device and the input terminal of the amplifier.

4. The delay time adjustment device according to claim 2, wherein the differential phase shift keying is differential binary phase shift keying (DBPSK), and one said balanced receiver is provided.

5. The delay time adjustment device according to claim 2, wherein the differential phase shift keying is differential quadrature phase shift keying (DQPSK), and two said balanced receivers are provided.

6. The delay time adjustment device according to claim 1,
wherein two said balanced receivers are provided,
wherein four amplifiers of the two balanced receivers are provided in such a way as not to adjacently output electrical signals to be combined,
wherein said two balanced receiver comprise
a first flexible substrate for connecting the output terminals of two of the amplifiers for outputting two first electrical signals to be combined and a signal line for combining both electrical signals; and
a second flexible substrate for connecting the output terminals of two of the amplifiers for outputting two second electrical signals to be combined and a signal line for combining both electrical signals.

7. The delay time adjustment device according to claim 6, wherein each of the first and second flexible substrates has an almost Y character shape.

8. The delay time adjustment device according to claim 7, wherein the lengths of the two branching units of the first and second flexible substrates are equal.

9. The delay time adjustment device according to claim 6, wherein the lengths of the two branching units of the first and second flexible substrates are different.

10. The delay time adjustment device according to claim 1, further comprising:
a first wire for connecting the terminal of the first photo acceptance device and the input terminal of the first amplifier; and
a second wire for connecting the terminal of the second photo acceptance device and the input terminal of the second amplifier.

11. The delay time adjustment device according to claim 10, wherein the lengths of the first and second wires are different.

12. The delay time adjustment device according to claim 11, wherein the first and second amplifiers are provided in parallel.

13. The delay time adjustment device according to claim 10, wherein the lengths of the first and second wires are equal.

14. The delay time adjustment device according to claim 13, wherein the first and second amplifiers are not provided in parallel.

15. The delay time adjustment device according to claim 11, wherein a terminal to which the first wire of the first photo acceptance device is connected and a terminal to which the second wire of the second photo acceptance device is connected are provided in different positions of a wiring direction.

16. The delay time adjustment device according to claim 10, wherein a horizontal distance between the output terminal of the first amplifier and the front end of a signal line on which the combination is performed and a horizontal distance between the output terminal of the second amplifier and the front end of a signal line on which the combination is performed are different.

17. The delay time adjustment device according to claim 1, wherein the flexible substrates are connected in a loop.

18. The delay time adjustment device according to claim 1, wherein the flexible substrate comprises a grounded coplanar waveguide, via the signal line of the grounded coplanar waveguide, the output of the pair of amplifiers and a signal line for combining the photoelectrically converted of the two branched optical signals are connected.

19. The delay time adjustment device according to claim 1, wherein the flexible substrate comprises a coplanar waveguide, via the signal line of the coplanar waveguide, the output of the pair of amplifiers and a signal line for combining the photoelectrically converted of the two branched optical signals are connected.

20. The delay time adjustment device according to claim 1, wherein the flexible substrate comprises a micro split line, via the signal line of the micro split line, the output of the pair of amplifiers and a signal line for combining the photoelectrically converted of the two branched optical signals are connected.

21. An optical receiver provided with a delay time adjustment device for adjusting in such a way that the delay times of two branched optical signals obtained by branching a received optical signal in a delay interferometer can be matched when both branched optical signals are converted into electrical signals by a photo acceptance device and are combined after both branched optical signals interfere with each other in the delay interferometer in a photo acceptance device for demodulating an optical signal modulated by DBPSK,
wherein said delay time adjustment device comprising: at least one balanced receiver,
wherein said balanced receiver comprises
a pair of photo acceptance devices for photoelectrically converting the two branched optical signals separately;
a pair of amplifiers provided in correspondence with the pair of photo acceptance devices, for receiving/amplifying photoelectrically converted signals outputted from a corresponding photo acceptance device; and
a flexible substrate for connecting the output terminals of the pair of amplifiers and a signal line on which the photoelectrically converted signals of the two branched optical signals are combined and adjusting the delay times of the two branched optical signals when branched optical signals are combined.

22. The optical receiver according to claim 21, wherein the balanced receiver comprises
a first photo acceptance device for converting one branched optical signal which must be outputted from the interferometer and must be combined into a first electrical signal;
a first electrical amplifier for amplifying and outputting the electrical signal outputted from the first photo acceptance device;
a first flexible substrate for connecting the output terminal of the first electrical amplifier and a signal line on which the combination is performed;
a second photo acceptance device for converting the other branched optical signal which must be outputted from the interferometer and must be combined into a second electrical signal;
a second electrical amplifier for amplifying and outputting the electrical signal outputted from the second photo acceptance device; and
a second flexible substrate for connecting the output terminal of the second electrical amplifier and a signal line on which the combination is performed.

23. The optical receiver according to claim 21,
wherein two said balanced receivers are provided,
wherein four amplifiers of the two balanced receivers are provided in such a way as not to adjacently output electrical signals to be combined,
wherein said two balanced receivers comprise
a first flexible substrate for connecting the output terminals of two of the amplifiers for outputting two first electrical signals to be combined and a signal line for combining both electrical signals and
a second flexible substrate for connecting the output terminals of two of the amplifiers for outputting two second electrical signals to be combined and a signal line for combining both electrical signals.

24. An optical receiver provided with the delay time adjustment device for adjusting in such a way that the delay times of two branched optical signals obtained by branching a received optical signal in a delay interferometer can be matched when both branched optical signals are converted into electrical signals by a photo acceptance device and are combined after both branched optical signals interfere with each other in the delay interferometer in a photo acceptance device for demodulating an optical signal modulated by DQPSK,
wherein said delay time adjustment device comprising: at least one balanced receiver,
wherein said balanced receiver comprises
a pair of photo acceptance devices for photoelectrically converting the two branched optical signals separately;
a pair of amplifiers provided in correspondence with the pair of photo acceptance devices, for receiving/amplifying photoelectrically converted signals outputted from a corresponding photo acceptance device; and
a flexible substrate for connecting the output terminals of the pair of amplifiers and a signal line on which the photoelectrically converted signals of the two branched optical signals are combined and adjusting the delay times of the two branched optical signals when branched optical signals are combined.

25. The optical receiver according to 24, wherein said balanced receiver comprises
a first photo acceptance device for converting one branched optical signal which must be outputted from the interferometer and must be combined into a first electrical signal;
a first electrical amplifier for amplifying and outputting the electrical signal outputted from the first photo acceptance device;
a first flexible substrate for connecting the output terminal of the first electrical amplifier and a signal line on which the combination is performed;
a second photo acceptance device for converting the other branched optical signal which must be outputted from the interferometer and must be combined into a second electrical signal;
a second electrical amplifier for amplifying and outputting the electrical signal outputted from the second photo acceptance device; and
a second flexible substrate for connecting the output terminal of the second electrical amplifier and a signal line on which the combination is performed.

26. The optical receiver according to claim 24,
wherein two said balanced receivers are provided,
wherein four amplifiers of the two balanced receivers are provided in such a way as not to adjacently output electrical signals to be combined,
wherein said two balanced receivers comprise
a first flexible substrate for connecting the output terminals of two of the amplifiers for outputting two first electrical signals to be combined and a signal line for combining both electrical signals; and
a second flexible substrate for connecting the output terminals of two of the amplifiers for outputting two second electrical signals to be combined and a signal line for combining both electrical signals.

27. The optical receiver according to claim 21, wherein the photo acceptance device and the flexible substrate are hermetically sealed.

28. The delay time adjustment device according to claim 3, wherein the differential phase shift keying is differential binary phase shift keying (DBPSK), and one said balanced receiver is provided.

29. The delay time adjustment device according to claim 3, wherein the differential phase shift keying is differential quadrature phase shift keying (DQPSK), and two said balanced receivers are provided.

30. The delay time adjustment device according to claim 13, wherein a terminal to which the first wire of the first photo acceptance device is connected and a terminal to which the second wire of the second photo acceptance device is connected are provided in different positions of a wiring direction.

31. The delay time adjustment device according to claim 2, wherein the flexible substrates are connected in a loop.

32. The delay time adjustment device according to claim 6, wherein the flexible substrates are connected in a loop.

33. The delay time adjustment device according to claim 2, wherein the flexible substrate comprises a grounded coplanar waveguide, via the signal line of the grounded coplanar waveguide, the output of the pair of amplifiers and a signal line for combining the photoelectrically converted of the two branched optical signals are connected.

34. The delay time adjustment device according to claim 6, wherein the flexible substrate comprises a grounded coplanar waveguide, via the signal line of the grounded coplanar waveguide, the output of the pair of amplifiers and a signal line for combining the photoelectrically converted of the two branched optical signals are connected.

35. The delay time adjustment device according to claim 2, wherein the flexible substrate comprises a coplanar waveguide, via the signal line of the coplanar waveguide, the output of the pair of amplifiers and a signal line for combining the photoelectrically converted of the two branched optical signals are connected.

36. The delay time adjustment device according to claim 6, wherein the flexible substrate comprises a coplanar waveguide, via the signal line of the coplanar waveguide, the output of the pair of amplifiers and a signal line for combining the photoelectrically converted of the two branched optical signals are connected.

37. The delay time adjustment device according to claim 2, wherein the flexible substrate comprises a micro split line, via the signal line of the micro split line, the output of the pair of amplifiers and a signal line for combining the photoelectrically converted of the two branched optical signals are connected.

38. The delay time adjustment device according to claim 6, wherein the flexible substrate comprises a micro split line, via the signal line of the micro split line, the output of the pair of amplifiers and a signal line for combining the photoelectrically converted of the two branched optical signals are connected.

39. The optical receiver according to claim 24, wherein the photo acceptance device and the flexible substrate are hermetically sealed.
